(19) United States
(12) Patent Application Publication
(10) Pub. No.: US 2006/0151574 A1
(43) Pub. Date: Jul. 13, 2006

(54) Formulations useful against hepatitis C virus infections

(75) Inventors: Thomas Herget, Darmstadt (DE); Bert Klebl, Gunzlhofen (DE)

Correspondence Address: FISH & NEAVE IP GROUP;ROPES & GRAY LLP, ONE INTERNATIONAL PLACE, BOSTON, MA, 02110-2624, US

(73) Assignee: GPC Biotech AG, Martinsried / Munich (DE)

(21) Appl. No.: 10/536,950

(22) PCT Filed: Dec. 1, 2003
(86) PCT No.: PCT/EP03/13514

§ 371 Date: Nov. 16, 2005

Related U.S. Application Data
(60) Provisional application No. 60/430,367, filed on Dec. 3, 2002.
(60) Provisional application No. 60/446,246, filed on Feb. 11, 2003.

(30) Foreign Application Priority Data
Nov. 29, 2002 (DE) 102 55 861.2
Feb. 7, 2003 (DE) 103 05 138.4

(51) Int. Cl. A47J 36/02

(52) U.S. Cl. 228/101

(57) ABSTRACT

The present invention relates generally to chemical compounds and substances which are effective against Hepatitis C virus (HCV) infections. Moreover, the present invention relates to compositions comprising said compounds and/or substances, to methods for preventing HCV infections as well use of the compounds and/or substances for the preparation of compositions useful for the prophylaxis and/or treatment of HCV infections. Useful compounds and substances according to the invention are selenium, selenium salts, Vitamin D₃ and retinoids, like all trans retinoic acid and salts thereof, C₁-C alkyl amides of all trans retinoic acid and salts thereof, C₁-C₁₀ alkyl esters of all trans retinoic acid and salts thereof, 9-cis retinoic acid and salts thereof, C₁-C₁₀ alkyl amides of 9-cis retinoic acid and salts thereof, C₁-C₁₀ alkyl esters of 9-cis retinoic acid and salts thereof, (E)-4-[2(5,6,7,8-tetrahydro-5,5,8,8-tetra methyl-2-naphthalenyl-1-propenyl)benzoic acid (TTNPB), (4-[5,6,7,8-tetrahydro5,5,8,8-tetramethyl-2-naphthalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (AHPN).

The present invention relates to chemical compounds and substances which are effective against Hepatitis C virus (HCV) infections. In particular, the present invention relates to compositions comprising said compounds and/or substances, to methods for preventing HCV infections as well as use of the compounds and/or substances for the preparation of compositions useful for the prophylaxis and/or treatment of HCV infections.

### BACKGROUND OF THE INVENTION

Hepatitis C Virus (HCV) infection Is a major cause of chronic hepatitis, cirrhosis and hepatocellular carcinoma. The WHO estimates that approximately 3% of the world population, or 170 million people, have been infected with the Hepatitis C Virus. In the U.S., an estimated 3.9 million Americans have been infected (CDC fact sheet September 2000). Over 80% of HCV-infected individuals develop chronic hepatitis, which is associated with disease states ranging from asymptomatic carrier states to repeated inflammation of the liver and serious chronic liver disease. Over the course of 20 years, more than 20% of chronic HCV-patients are expected to be at risk to develop cirrhosis or progress to hepatocellular carcinoma. Liver failure from chronic hepatitis C is the leading indicator for liver transplantation. Excluding transplantation, the CDC estimates that medical and work-loss cost for HCV annually are around US-$ 600 million. HCV is transmitted primarily by blood and blood products. Due to routine screening of the blood supplies from mid-1992, new transfusion-related cases are exceedingly rare and have been surpassed by injection drug use as the highest risk factor for acquiring the virus. There is also a sexual, however inefficient, route of transmission, and a 6% rate of transmission from infected mothers to their children, which is higher in case of HIV co-infection. In a certain percentage of infections, the mode of transmission remains unknown. In spite of the significant decline in incidence in the 1990's, the number of deaths (estimated deaths annually at the moment: 8000 to 10,000 in U.S.) and severe disease due to HCV is anticipated to triple in the next 10 to 20 years (sources: CDC fact sheet (accessed Dec. 12, 2000); Houghton M.

Hepatitis C Viruses. In B N Fields, D M Knipe, P M Howley (ed.) Fields Virology. 1996. Lippencott-Raven Pub., Philadelphia; Rosen H R and Gretch D R, Molecular Medicine Today Vol 5, 393, September 99; Science 285, 26, July 99: News Focus: The scientific challenge of Hepatitis C; Wong J B et al, Am J Public Health, 90, 1562, October 2000: Estimating future. hepatitis C morbidity, mortality, and costs in the United States).

According to the announcement from the EASL (European Association for the Study of the Liver) International Consensus Conference on Hepatitis C (Feb. 26-28, 1999, Paris, France), combination therapy of alpha interferon and ribavirin is the recommended treatment for naive patients. Monotherapy with interferon has also been approved by the FDA, but the sustained response rate (HCV RNA remains undetectable in the serum for more than 6 months after end of therapy) is only 15 to 20%, in contrast to 35 to 45% with combination therapy. Interferons (Intron A, Schering-Plough; Roferon A, Hoffmann-LaRoche; Wellferon, Glaxo Wellcome; Infergen, Amgen) are injected subcutaneously three times a week, ribavirin (Rebetol, Schering-Plough) is an oral drug given twice a day. Recommended treatment duration is 6 to 12 months, depending on HCV genotype. Experimental forms of slow-release pegylated interferons (Pegasys, Hoffmann-LaRoche; PEG-Intron, Schering-Plough) have shown improvements in response rates (42 to 82% in combination with ribavirin) and application (once-weekly injection) in recent clinical studies (Hepatology 32:4, Pt 2 of 2. October 2000; NEJM 343, 1673. December 2000; NEJM 343, 1666. December 2000). Common side effects of interferon therapy include: e.g. fatigue, muscle aches, head aches, nausea, fever, weight loss, irritability, depression, bone marrow suppression, reversible hair loss. The most common side effects of ribavirin are anemia, fatigue and irritability, itching, skin rash, nasal stuffiness, sinusitis, cough. More serious side effects of mono- and combination therapy occur in less than two percent of patients (NIDDK information: Chronic Hepatitis C: Current Disease Management. accessed Sep. 12, 1999). Some of the contraindications to interferon are psychosis or severe depression; neutropenia and/or thrombocytopenia; organ transplantation except liver; symptomatic heart disease; decompensated cirrhosis; uncontrolled seizures. Contraindications to ribavirin are end-stage renal failure; anemia; hemoglobinopathies; severe heart disease; pregnancy; no reliable method of contraception (consensus statement EASL). Moreover, treatment of Hepatitis C virus infection with interferon-alpha is effective in only a minority of individuals. This suggests that the virus may use various tricks to be resistant to interferon.

Review articles by Vogel, “Peginterferon-α₂ₐ (40 kDa)/ribavirin combination for the treatment of chronic hepatitis C infection”, Expert Rev. Anti-infect. Ther. 1 (3), 423-431 (2003) and Durantel et al., “Current and emerging therapeutic approaches to hepatitis C infection”, Expert Rev. Anti-infect. Ther. 1 (3), 441-454 (2003) provide an overview of the current status of HCV therapy. According to these articles, current treatment involves association of two molecules, standard (i.e. non-pegylated) or pegylated interferon and ribavirin. Although this therapy induces a sustained virologic response in 50 to 60% of the cases, there are still a high number of so-called ‘non-responders’ and treatment is often limited by the above-mentioned side effects. Particularly for non responding patients, and more generally, for improving the current clinical practice, it is important to develop alternative and effective therapeutic approaches for HCV treatment.

If in the following the terms “non-responder(s) to interferon and/or ribavirin therapy” or “non responding patient(s) to interferon and/or ribavirin therapy” are used, these terms shall denote the portion of the HCV infected individuals (particularly humans) who do not show a positive reaction or total cure when treated with pegylated or non-pegylated (standard) α-, β-, or γ-interferon alone (so-called interferon monotherapy), ribavirin alone (so-called ribavirin monotherapy), or a combination therapy of pegylated or non-pegylated (standard) α-, β-, or γ-interferon and ribavirin. Non-responders can be patients who are non responding to interferon and/or ribavirin treatment from the very beginning of a therapy, or who become non responding after a certain time of an interferon and/or ribavirin treatment.

Experimental treatments that are not new forms of Interferon are Maxamine (histamine dihydrochloride, Maxim Pharmaceuticals), which will be combined with Interferon in phase III studies, VX-497 (Vertex Pharmaceuticals), an IMP dehydrogenase inhibitor, as a less toxic ribavirin substitute in phase II, and amantadine (Endo Labs), an approved influenza drug, as the third component in triple therapy (phase II). Inhibitors for HCV enzymes such as protease inhibitors, RNA dependent RNA polymerase inhibitors, helicase inhibitors as well as ribozymes and antisense RNAs are under preclinical development (Boehringer Ingelheim, Ribozyme Pharmaceuticals, Vertex Pharmaceuticals, Schering-Plough, F Hoffmann-LaRoche, Immusol, Merck etc.). No vaccine is available for prevention or therapeutic use, but several companies are trying to develop conventional or DNA vaccines or immunostimulatory agents (e.g. Chiron, Merck/Vical, Epimmune, NABI, Innogenetics). In addition, antibodies against HCV virion have been developed and entered into clinical trials recently (Trimera Co., Israel).

In summary, the available treatment for chronic Hepatitis C is expensive, effective only in a certain percentage of patients and adverse side effects are not uncommon.

WO 02/066022 A1 describes a method of treating hepatitis comprising administering to a subject in need of such treatment a therapeutically effective amount of retinoid such as all-trans retinoic acid. In particular embodiments, the form of hepatitis is Hepatitis A, B, C, D, E and G and the treatment is with liposomal all-trans retinoic acid.

### DESCRIPTION OF THE INVENTION

Recent research has revealed how cells communicate with each other to coordinate the growth and maintenance of the multitude of tissues within the human body. A key element of this communication network is the transmission of a signal from the exterior of a cell to its nucleus, which results in the activation or suppression of specific genes. This process is called signal transduction.

Signal transduction at the cellular level refers to the movement of signals from outside the cell to inside. The movement of signals can be simple, like that associated with receptor molecules of the acetylcholine class: receptors that constitute channels which, upon ligand interaction, allow signals to be passed in the form of small ion movement, either into or out of the cell. These ion movements result in changes in the electrical potential of the cells that, in turn, propagates the signal along the cell. More complex signal transduction involves the coupling of ligand-receptor interactions to many intracellular events. These events include phosphorylations by tyrosine kinases and/or serine/threonine kinases. Protein phosphorylations change enzyme activities and protein conformations. The eventual outcome is an alteration in cellular activity and changes in the program of genes expressed within the responding cells.

Signal transducting receptors are of three general classes:

1. Receptors that Penetrate the Plasma Membrane and have Intrinsic Enzymatic Activity:

Receptors that have intrinsic enzymatic activities include those that are tyrosine kinases (e.g. PDGF, insulin, EGF and FGF receptors), tyrosine phosphatases (e.g. CD45 [cluster determinant-45] protein of T cells and macrophages), guanylate cyclases (e.g. natriuretic peptide receptors) and serine/threonine kinases (e.g. activin and TGF-beta receptors). Receptors with intrinsic tyrosine kinase activity are capable of autophosphorylation as well as phosphorylation of other substrates.

Additionally, several families of receptors lack intrinsic enzyme activity, yet are coupled to intracellular tyrosine kinases by direct protein-protein interactions. This class of receptors includes all of the cytokine receptors (e.g. the interleukin-2 receptor) as well as the CD4 and CD8 cell surface glycoproteins of T cells and the T cell antigen receptor.

2. Receptors that are Coupled, Inside the Cell, to GTP-Binding and Hydrolyzing Proteins (Termed G-Proteins):

Receptors of the class that interact with G-proteins all have a structure that is characterized by seven transmembrane spanning domains. These receptors are termed serpentine receptors. Examples of this class are the adrenergic receptors, odorant receptors, and certain hormone receptors (e.g. glucagon, angiotensin, vasopressin and bradykinin).

3. Receptors that are Found Intracellularly and Upon Ligand Binding Migrate to the Nucleus where the Ligand-Receptor Complex Directly Affects Gene Transcription:

The steroid/thyroid hormone receptor superfamily (e.g. glucocorticoid, vitamin D, retinoic acid and thyroid hormone receptors) is a class of proteins that reside in the cytoplasm and bind the lipophilic steroid/thyroid hormones. These hormones are capable of freely penetrating the hydrophobic plasma membrane. Upon binding ligand the hormone-receptor complex translocates to the nucleus and bind to specific DNA sequences resulting in altered transcription rates of the associated gene.

When the message reaches the nucleus via one or several of the pathways described above, it initiates the modulation of specific genes, resulting in the production of RNA and finally proteins that carry out a specific biological function. Disturbed activity of signal transduction molecules may lead to the malfunctioning of cells and disease processes. Specifically, interaction of HCV with host cells is necessary for the virus to replicate.

The present invention is based upon the fact that the human cellular protein glutathione peroxidase-gastrointestinal (P18283) is specifically downregulated as a result of HCV replication in HCV infected host cells. The antiviral prophylactic and/or therapeutic approach described herein focuses on specific chemical substances and compounds that can be used to upregulate the human cellular protein glutathione peroxidase-gastrointestinal. These specific chemical substances and compounds are selenium, selenium salts, Vitamin D₃, pegylated and non-pegylated (standard) α-, β-, and γ-interferon, ribavirin, and retinoids, particularly all isomeric forms of retinoic acid, like all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, 13-cis retinoic acid, salts of 13-cis retinoic acid, C₁-C₁₀ alkyl esters of 13-cis retinoic acid, salts of C₁-C₁₀ alkyl esters of 13-cis retinoic acid, C₁-C₁₀ alkyl amides of 13-cis retinoic acid, salts of C₁-C₁₀ alkyl amides of 13-cis retinoic acid, as well as (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphtalenyl)carboxamido]benzoic acid (AM-580), N-(4-hydroxyphenyl)retinamide (4-HPR) and 6-[3-1-adamantyl)-4-hydroxyphenyl]-2-naphthalene carboxylic acid (CD437; AHPN).

According to a further aspect of the present invention, it is preferred that together with one or more of the above-mentioned substances paraquat is used as antiviral prophylactic and/or therapeutic substance that can be used to upregulate the human cellular protein glutathione peroxidase-gastrointestinal.

Preferred is the use of all trans retinoic acid or 13-cis retinoic acid for the treatment of non-responders. Also preferred is the use of compositions comprising all trans retinoic acid or 13-cis retinoic acid with one of the chemical substances mentioned above for the treatment of HCV infections or HCV infection related diseases. Particularly, (i) all trans retinoic acid is used with selenium and/or selenium salts, (ii) all trans retinoic acid is used with pegylated and/or non-pegylated (standard) α-, β-, and γ-interferon, (iii) all trans retinoic acid is used with pegylated and/or non-pegylated (standard) α-, β-, and/or γ-interferon and ribavirin, (iv) all trans retinoic acid is used with pegylated and/or non-pegylated (standard) α-, β-, and/or γ-interferon and with selenium and/or a selenium salt, (v) all trans retinoic acid is used in combination with ribavirin and selenium and/or a selenium salt, and (vi) all trans retinoic acid and ribavirin. In case of combination (v), all trans retinoic acid is preferably used at a concentration of 0.1 to 10 μM, more preferably 0.5 to 2.5 μM, and particularly 1 μM, selenium or selenium salts are preferably used at a concentration of 1 to 200 nM, more preferably 10 to 100 nM, and particularly 50 nM, ribavirin is preferably used at a concentration of 1 to 500 μM, more preferably 10 to 100 μM, and particularly 50 μM. The above-mentioned combinations (i), (ii), (iii), (iv), and (v) can be used both for the treatment of responders and non-responders.

In addition, the following compounds shall be encompassed by the term “retinoids” as used within the present application. In particular, the further retinoids as understood according to the present application also refer to retinol, etretinate, amides of the all-trans-retinoic acid or 13-cis-retinoic acid with 2-aminoethanol, alpha-L-serine, alpha-L-threonine, alpha-L-tyrosine containing phosphate groups.

The structure of these further retinoids is covered by the following general formula:
R—CONH—X—OPO(OH)₂,

wherein

R is 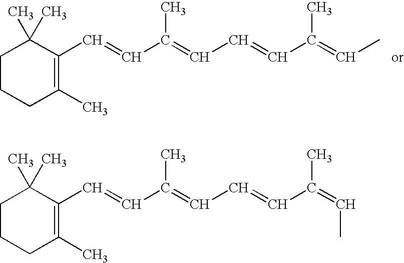
and X is
—CH₂—CH₂
or
—CH(CO₂H)—CH₂—
or
—CH(CO₂H)—CH(CH₃)—
or
—CH(CO₂H)—CH₂—C₆H₅—

Thus the amino group of 2-aminoethanol or the alpha-amino group of amino acid forms an amide bond with the carboxylic group of all-trans-retinoic acid or 13-cis retinoic acid. At the same time the hydroxyl group of 2-aminoethanol and the amino acid is modified by a phosphate residue.

Retinoids falling under the further retinoids according to the present Invention are e.g. described In U.S. Pat. No. 6,326,397 B1 and U.S. Pat. No. 6,403,554 B2, which are incorporated herein by reference in their entirety. In these two US patents, among other substances amides of all-trans-retinoic acid or 13-cis-retinoic acid with 2-aminoethanol, alpha-L-serine, alpha-L-threonine, alpha-L-tyrosine are disclosed. At the same time hydroxyl groups of amino acids and 2-aminoethanol are modified by phosphate residues. The all-trans-retinoic acid or 13-cis retinoic acid have been derived by various procedures from naturally-occurring products. It is however possible, within the scope of the present invention, to produce these compound synthetically. Examples how to synthesize the further retinoids according to the present invention are described in the above-mentioned patents U.S. Pat. No. 6,326,397 B1 and U.S. Pat. No. 6,403,554 B2.

The main characteristic among the synthesised compounds is the phosphorylation of the hydroxyl groups of N-acyl derivatives of amino acids and 2-aminoethanol.

Further retinoids (retinoic acid derivatives) according to the present invention include the following compounds:

1. N-(all-trans-retinoyl)-o-phospho-2-aminoethanol

1a. N-(13-cis-retinoyl)-phospho-2-aminoethanol

2. N-(all-trans-retinoyl)-phospho-L-serine

2a. N-(13-cis-retinoyl)-phospho-L-serine

3. N-(all-trans-retinoyl)-o-phospho-L-threonine

3a. N-(13-cis-retinol)-o-phospho-L-threonine

4. N-(all-trans-retinoyl)-o-phospho-L-tyrosine

4a. N-(13-cis-retinoyl)-o-phospho-L-tyrosine

The structural formulas of the above-mentioned compounds are presented below:

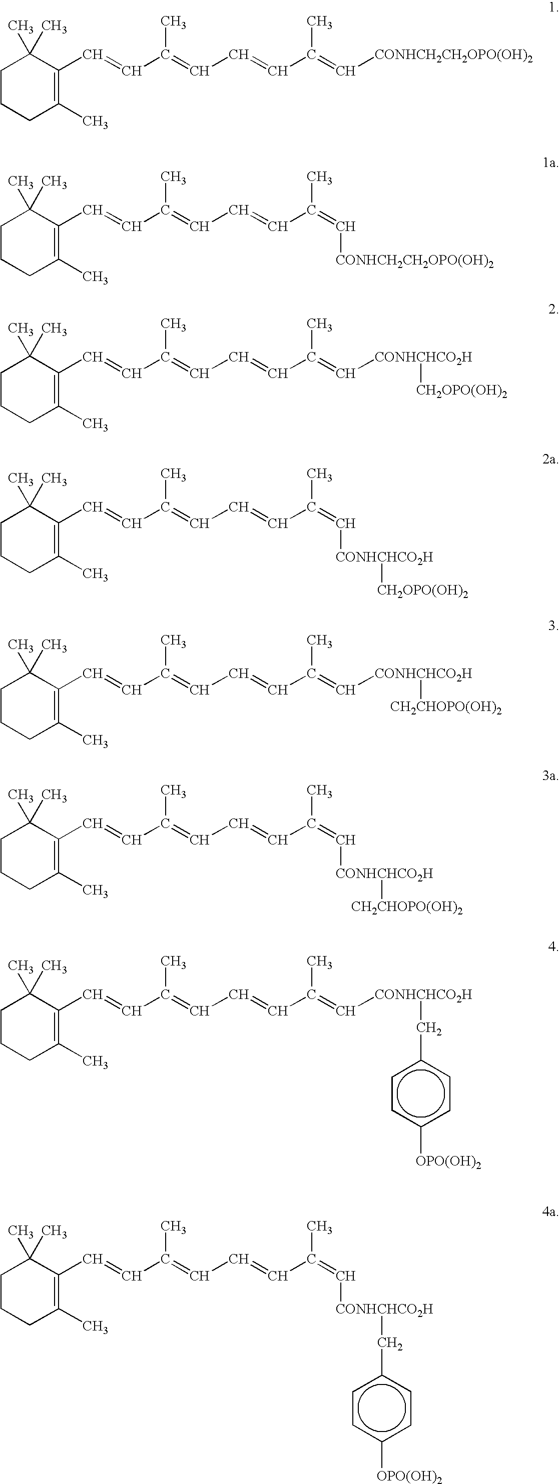

Moreover, also the retinoid antagonists described in U.S. Pat. No. 6,326,397 B1 do fall under the retinoids according to the present invention. The contents of U.S. Pat. No. 6,326,397 B1 is herewith incorporated in its entirety into the present application. Specifically, the present application also relates to compounds of the formula I 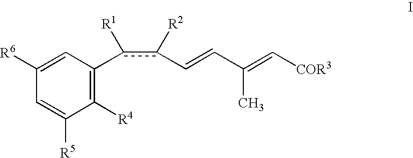
wherein the dotted bond can be either hydrogenated or form a double bond; and, when the dotted bond forms a double bond, R¹ is lower alkyl and R² is hydrogen; and, when the dotted bond is hydrogenated, R¹ and R² taken together are methylene to form a cis-substituted cyclopropyl ring; R³ is hydroxy or lower alkoxy; R⁴ is alkyl or alkoxy; and R⁵ and R⁶ are, independently, a C₄-C₁₂ alkyl or a 5-12 cycloalkyl substituent containing from 1-3 rings which are either unsubstituted or substituted with from 1-3 lower alkyl groups, with the carbon atom of R⁵ and R⁶ being linked to the remainder of the molecule to form a quaternary carbon atom and pharmaceutically acceptable salts of carboxylic acids of formula I.

As used herein the term “alkyl” means straight-chain, branched or cyclic alkyl residues, in particular those containing from 1 to 12 carbon atoms, such as methyl, ethyl, propyl, isopropyl, t-butyl, decyl, dodecyl, cyclopentyl, cyclohexyl, cycloheptyl and the like. The term “lower alkyl” means alkyl groups containing from 1 to 7, preferably 14 carbon atoms. Most preferred lower alkyl groups are methyl and ethyl. Alkyl and alkoxy groups denoted by R⁴ preferably contain 18 carbon atoms, more preferably 14 carbon atoms. Particularly preferred group R⁴ are ethoxy and butoxy. Examples of C₄₋₁₂ alkyl groups represented by R⁵ or R⁶ are tert.-butyl, 1,1-dimethylpropyl, 1-methyl-1-ethylpropyl, 1-methyl-1-ethylhexyl and 1,1-dimethyldecyl. Of these groups, tert.-butyl is preferred. When one of R⁵ and R⁶ is a 5 to 12 cycloalkyl hydrocarbon substituted, the substituent contains from 1 to 3 fused hydrocarbon rings which may be unsubstituted or substituted with from 1 to 3 lower alkyl groups. The substituents R⁵ and R⁶ are attached to the remainder of the molecule of formula I by a carbon atom which, when so attached, forms a quaternary carbon atom. Among the preferred mono- or polycyclic hydrocarbon substituents represented by R⁵ and R⁶ are 1-adamantyl and. 1-methylcyclohexyl.

In one embodiment, the invention comprises compounds of the formula I a 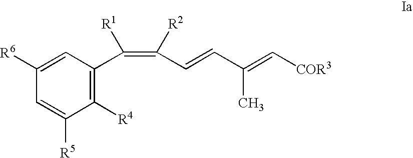
wherein R¹ is lower alkyl and R³ to R⁶ are as in formula I; and pharmaceutically acceptable salts of carboxylic acids of formula Ia.

In another embodiment the invention comprises compounds of the formula Ib: 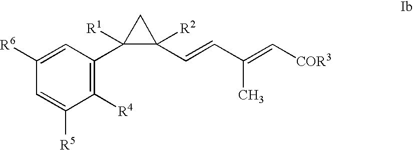
wherein R³ to R⁶ are as in formula I; and pharmaceutically acceptable salts of carboxylic acids of formula Ib.

The compounds of formula I wherein R¹ and R² taken together are methylene, may be present in pure enantiomeric form or as racemates. While formula Ib arbitrarily depicts a particular enantiomeric form it is to be understood that the invention also comprises the opposite enantiomers as well as the racemates.

Particularly preferred are compounds of the formula Ia wherein R¹ is methyl, R⁴ is ethoxy or butoxy and R⁵ and R⁶ are tert.-butyl.

The compounds of formula I above bind specifically to Retinoid X Receptors (RXR), but do not activate them. Accordingly the compounds of this invention can be used to reduce or abolish adverse events induced by retinoids (retinoid agonists) in patients.

In a further aspect, the present Invention relates to the use of retinoid antagonists comprising retinoids with selective Retinoic Acid Receptor (RAR) antagonistic activity, Retinoid X Receptor (RXR) antagonistic activity or mixed RAR-RXR antagonistic activity.

In accordance with that aspect of the invention the term “retinoid antagonists” is used for retinoids or compounds with RAR, RXR or mixed RAR-RXR antagonistic activity. It includes compounds with receptor neutral antagonistic activity (neutral antagonists), receptor inverse agonistic activity (inverse agonists) and negative hormone activity (negative hormones).

Thus, the term “retinoid antagonists” encompasses
a) RXR antagonists of the formula I given earlier herein, particularly those of the formula Ic 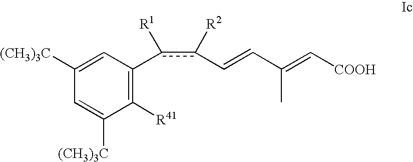
wherein the dotted bond is optional; and, when the doffed bond is present, R¹ is methyl and R² is hydrogen; and, when the dotted bond is absent, R¹ and R² taken together are methylene to form a cis-substituted cyclopropyl ring; and R⁴¹ is C₁₋₄-alkoxy;
b) RAR α-antagonists of formulae 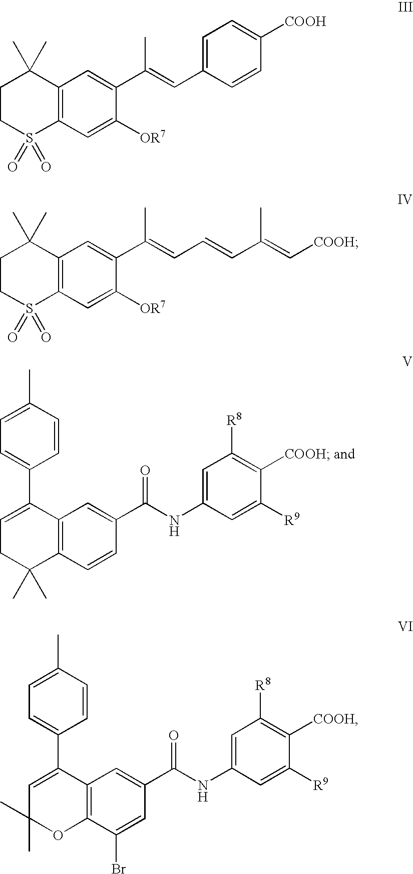
wherein R⁷ is C₅₋₁₀-alkyl, and R⁸ and R⁹ independently of each other are hydrogen or fluorine; such compounds being described in U.S. Pat. No. 5,391,766 and J. Med. Chem. 1997, 40, 2445;
c) RAR α,β antagonists of formulae 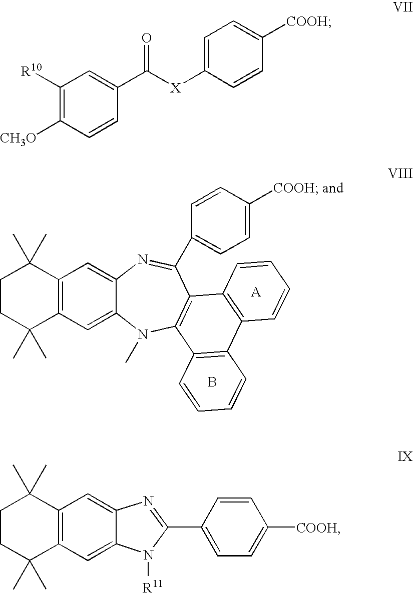
wherein R¹⁰ is diamantyl, X is O or NH, R¹¹ is phenyl or benzyl, and wherein optionally either ring A or ring B is present; such compounds being described in Med. Chem. Res. 1991, 1, 220; Biochem. Biophys. Res. Com. 1997, 231, 243; J. Med. Chem. 1994, 37, 1508;
d) RAR β,γ antagonists of formula 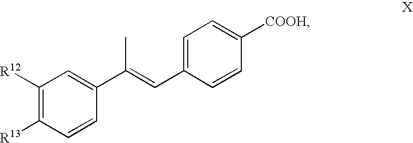
wherein R¹² and R¹³ independently of each other hydroxy, C₁₋₄-alkoxy, optionally branched C₁₋₅-alkyl or adamantyl; such compounds being described in J. Med. Chem. 1995, 38, 4993;
e) RAR γ antagonists of formulae 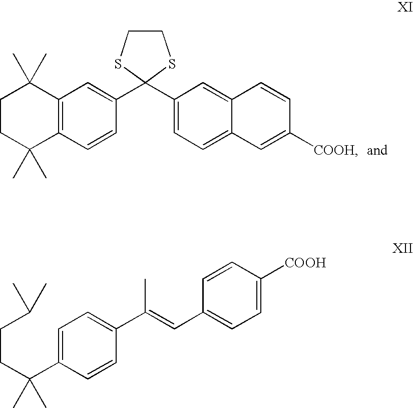
such compounds being described in Cancer Res. 1995, 55, 4446;
f) RAR α,β,γ antagonists of formulae 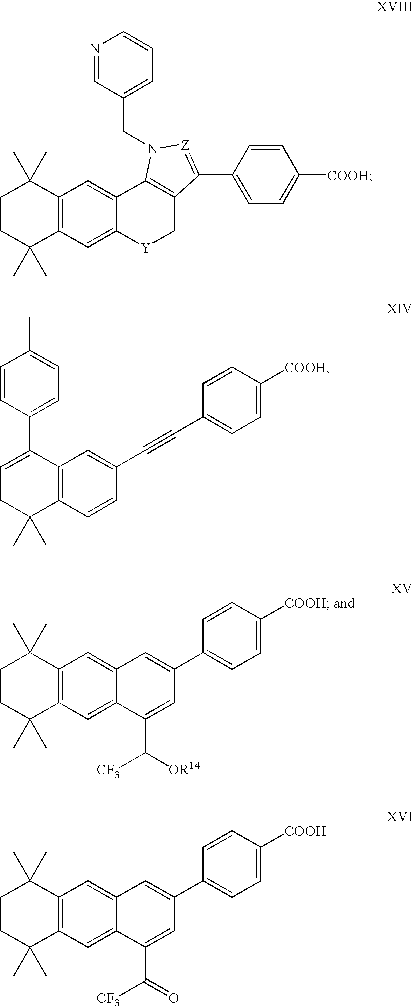
wherein Y is —CH₂— or sulfur and Z is —CH═ or nitrogen, and R¹⁴ is hydrogen or C₁₋₄-alkyl; such compounds being described in J. Med. Chem. 1995, 38, 3163 and 4764; J. Biol. Chem. 1996, 271, 11897 and 22692;
g) RXR antagonists of formula 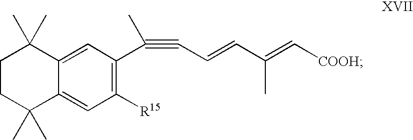
wherein R¹⁵ is C₁₋₄-alkoxy; such compounds being described in J. Med. Chem. 1996, 39, 3229; and Nature 1996, 383, 450, as well as pharmaceutically acceptable salts and pharmaceutically acceptable hydrolyzable esters of the compounds of formulae III to XVII.

In the scope of the present invention, the “pharmaceutically acceptable salts” includes any salt chemically permissible in the art for retinoids and particularly retinoid antagonists and applicable to human patients in a pharmaceutically acceptable preparation. Any such conventional pharmaceutically acceptable salt of retinoids or retinoid antagonists can be utilized. Among the conventional salts which can be utilized, there are the base salts included, for example, alkali metal salts such as the sodium or potassium salt, alkaline earth metal salts such as the calcium or magnesium salt, and ammonium or alkyl ammonium salts.

Moreover, the following substances disclosed in the commercially available database “Pharmaprojects” be considered to fall under the term “retinoids” according to the present invention.

| Originator | Generic Name | Chemical Structure |
|---|---|---|
| Allergan | AGN-181701 | 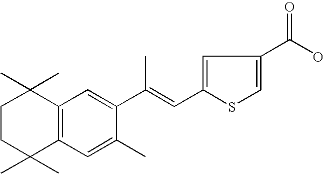 |
| Allergan | AGN-192174 | 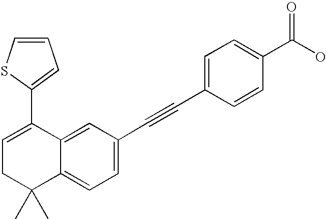 |
| Allergan | AGN-193676 | 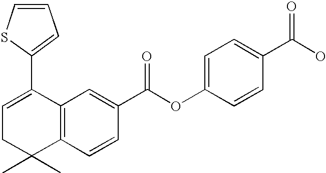 |
| Allergan | AGN-193836 | 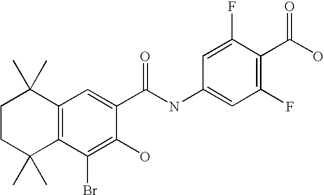 |
| Allergan | AGN-4326 | |
| Allergan | AGN-194310 | 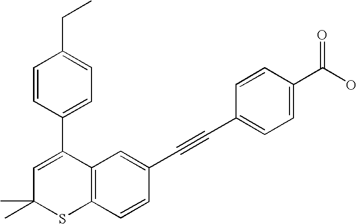 |
| Allergan | tazarotene | 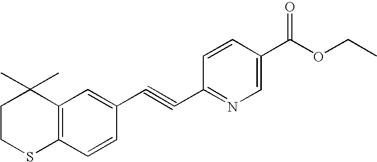 |
| Allergan | AGN-195183 | 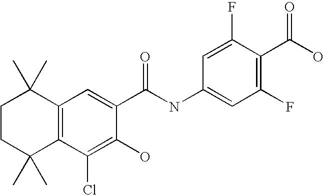 |
| Antigenics | retinoic acid, Antigenics | 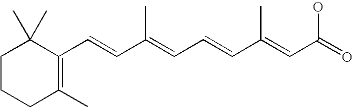 |
| AP Pharma | trans-retinoic acid, AP Pharma | 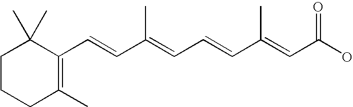 |
| Barrier | rambazole | |
| Therapeutics | | |
| Basilea Pharmaceutica | alitretinoin, Basilea | 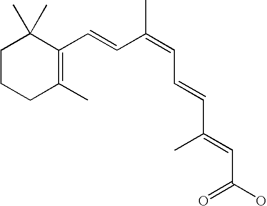 |
| BattellePharma | Isotretinoin, EHD delivery | 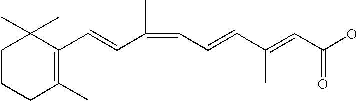 |
| Bristol-Myers Squibb | BMS-297208 | 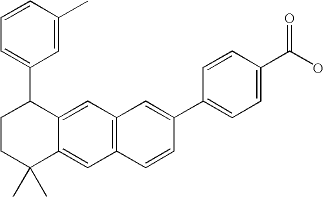 |
| Bristol-Myers Squibb | Pharmaprojects No. 6087 | 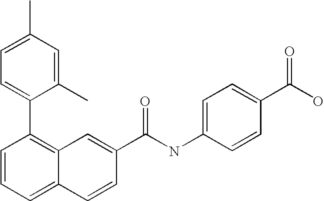 |
| Bristol-Myers Squibb | BMS-181163 | 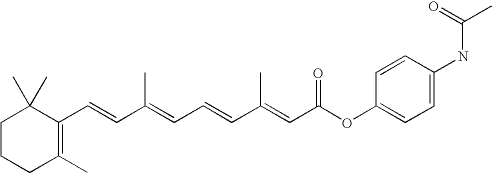 |
| Bristol-Myers | PLT-99257 | |
| Squibb | | |
| Clarion | CPR-2003 | |
| Eisai | ER-35794 | 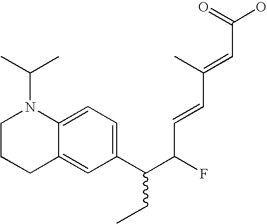 |
| Eisai | polypreic acid | 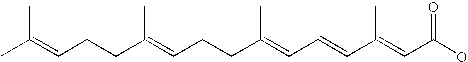 |
| Eisai | Pharmaprojects No. 5718 | 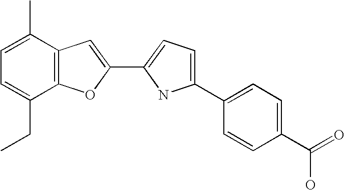 |
| Eisai | ER-34617 | 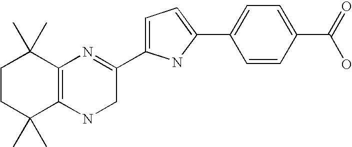 |
| Galderma | CD-437 | 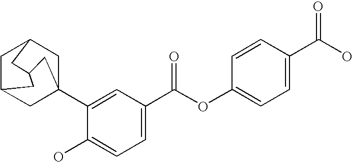 |
| Galderma | adapalene | 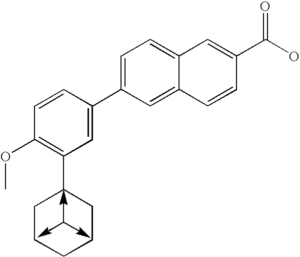 |
| Hoffmann-La Roche | etarotene | 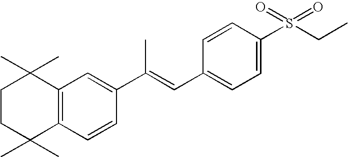 |
| Hoffmann-La Roche | etretinate | 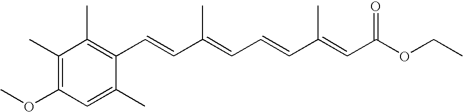 |
| Hoffmann-La Roche | issotertinoin | 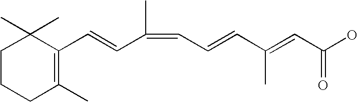 |
| Hoffmann-La Roche | motretinide | 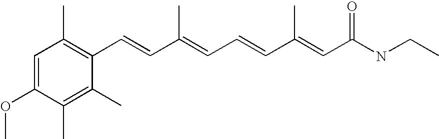 |
| Hoffmann-La Roche | Ro-11-0503 | 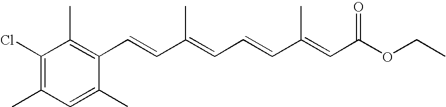 |
| Hoffmann-La Roche | Ro-13-6298 | 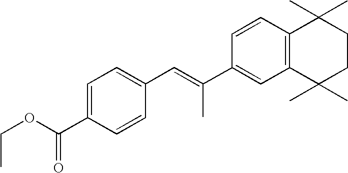 |
| Hoffmann-La Roche | Ro-23-2895 | 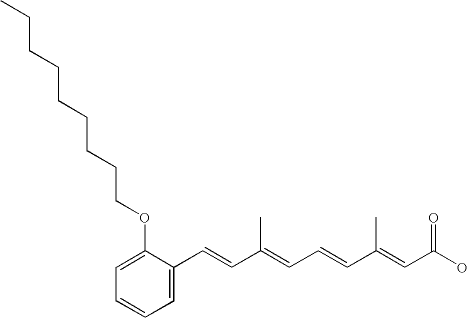 |
| Hoffmann-La Roche | sumarotene | 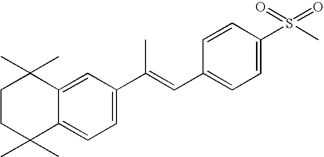 |
| Hoffmann-La | R-667 | |
| Roche | | |
| Hoffmann-La Roche | Pharmaprojects No. 5126 | 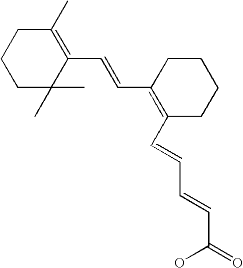 |
| Hoffmann-La Roche | tertinoin, Roche | 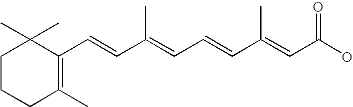 |
| Hoffmann-La Roche | Pharmaprojects No. 4858 | 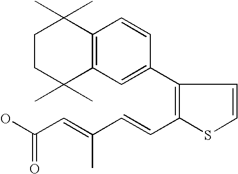 |
| Incyte | MX6 | |
| Corporation | | |
| Incyte Corporation | MX-781 | 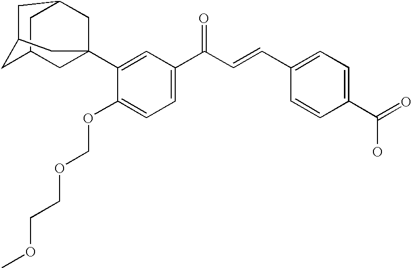 |
| Johnson & Johnson | Pharmaprojects No. 697 | 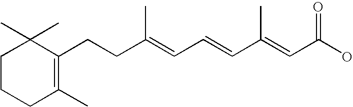 |
| Johnson & Johnson | Pharmaprojects No. 5849 | 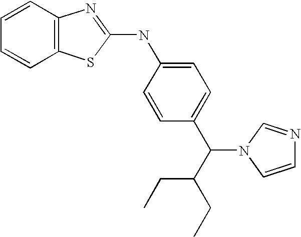 |
| Johnson & Johnson | tretinoin, Ortho | 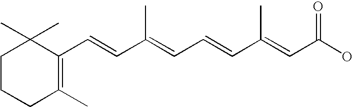 |
| Johnson & Johnson | fenretinide | 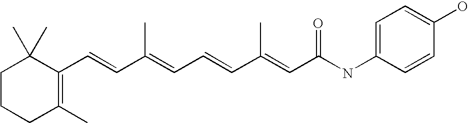 |
| Ligand | LGD-1550 | 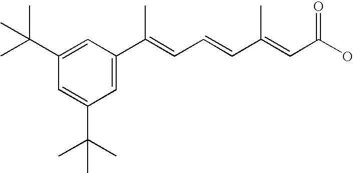 |
| Ligand | alltretinoin, gel, Ligand | 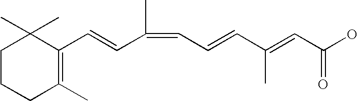 |
| Ligand | bexarotene, oral, Ligand | 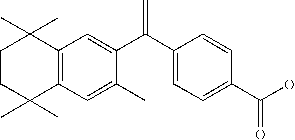 |
| Ligand | bexarotene, gel, Ligand | 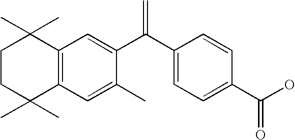 |
| Ligand | Pharmaprojects No. 4983 | 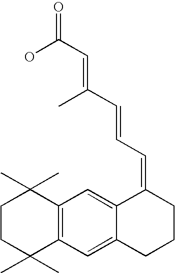 |
| Ligand | alitertinoin, oral, | |
| | Ligand | |
| Ligand | LY-929 | 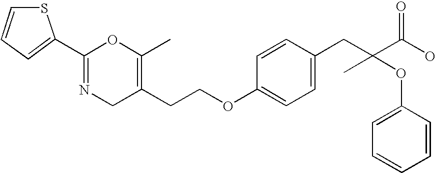 |
| Ligand | LG-100754 | 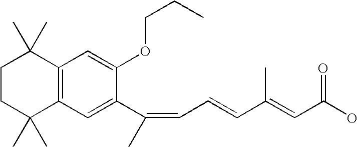 |
| Molecular Design | MDI-101 | |
| Molecular Design | MDI-301 | |
| Molecular Design | MDI-403 | |
| NIH | trans-retinoic acid, NIH | 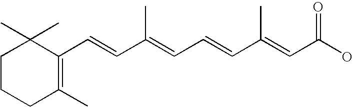 |
| NIH | 9-cis-retinoic acid, NCI | 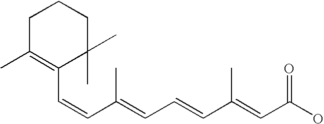 |
| Nisshin Pharma | tocoretinate | 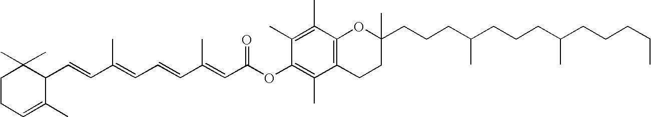 |
| Non-industrial source | TTNN | 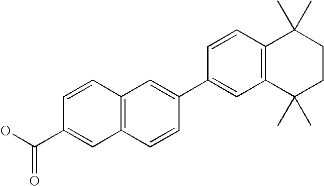 |
| Non-industrial source | RBAD | 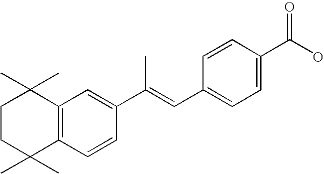 |
| Non-industrial source | Pharmaprojects No. 2187 | 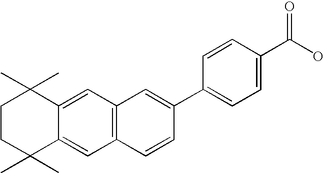 |
| Oxford BioMedica | RARβ2, gene ther, | |
| | Oxford Bio | |
| Pilot Therapeutics | PLT-99511 | |
| Scotia Pharmaceuticals | tertinoin, galactosome, Scotia | 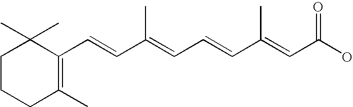 |
| Shionogi | AM-80 | 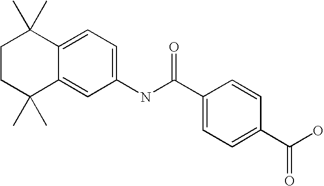 |
| SRI International | SRI-6409-40 | 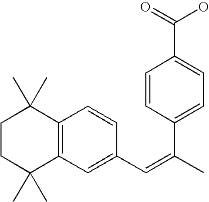 |
| SRI International | Pharmaprojects No. 3749 | 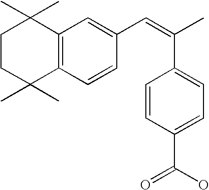 |
| SRI International | Pgarmaprojects No. 472 | 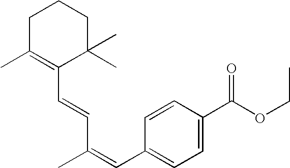 |
| SRI International | Pharmaprojects No. 1168 | 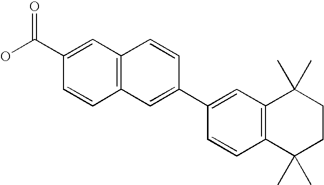 |
| Taiho | TAC-101 | 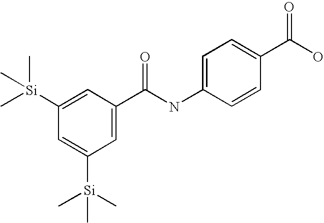 |
| UAB Research Foundation | UAB-30 | 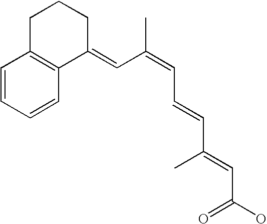 |
| Yamanouchi | clindamycin +teertinoin, Yaman | 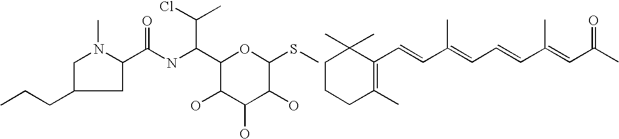 |

According to another embodiment of the present invention, further substances can be combined with the at least one of the above mentioned chemical substances and compounds. Such a further substance is paraquat. Paraquat is the trivial name for 1,1′-dimethyl-4,4′-bipyridinium, and a commercially available form of paraquat is e.g. 1,1′-dimethyl-4,4′-bipyridinium dichloride.

In order to develop new pharmaceutically active compounds, a potential target for medical intervention had to be identified. Thus, processes for finding pharmaceutically effective compounds include target identification. Details for finding a suitable target to deal with HCV infections are described in WO 02/084294.

Target identification is basically the identification of a particular biological component, namely a protein and its association with particular disease states or regulatory systems. A protein identified in a search for a pharmaceutically active chemical compound (drug) that can affect a disease or its symptoms is called a target. Said target is involved in the regulation or control of biological systems and its function can be interfered by with a drug.

The word disease is used herein to refer to an acquired condition or genetic condition. A disease can alter the normal biological system of the body, causing an over or under abundance of chemical compounds (chemical imbalance). The regulatory systems for these chemical compounds involve the use by the body of certain proteins to detect imbalances or cause the body to produce neutralizing compounds in an attempt to restore the chemical balance.

The word body is used herein to refer to any biological system, e.g. human, animal, cells, or cell culture.

It is therefore the object of the present invention to provide compounds, compositions and methods which are effective in the prophylaxis and/or treatment of Hepatitis C virus infections, but which do not show the negative side-effects described above or at least not to the extent reported for known products and methods. The object of the present invention is solved by the teaching of the independent claims. Further advantageous features, aspects and details of the invention are evident from the dependent claims, the description, and the examples of the present application.

### DETAILED DESCRIPTION OF THE INVENTION

It has been shown previously that the human cellular protein glutathione peroxidase-gastrointestinal is specifically downregulated in a body as a result of HCV infection. This human cellular protein glutathione peroxidase-gastrointestinal has been identified as a diagnostic and therapeutic target for dealing with HCV infection.

Glutathione Peroxidase:

Four distinct species of glutathione peroxidase have been identified in mammals to date, the classical cellular enzyme, the phospholipid hydroperoxide metabolizing enzyme, the gastroinestinal tract enzyme and the extracellular plasma enzyme. Their primary structures are poorly related. It has been shown that they are encoded by different genes and have different enzymatic properties. The physiological role of the human plasma enzyme remains still unclear due to the low levels of reduced glutathione in human plasma and the low reactivity of this enzyme.

The human cellular protein glutathione peroxidase-gastrointestinal (GI-GPx) is also known as glutathione peroxidase-related protein 2 (GPRP) or glutathione hydrogen peroxide oxidoreductase. It has been assigned to the Accession Number P18283 and the EC Number 1.11.1.9.

The human cellular protein glutathione peroxidase-gastrointestinal (GI-GPx) catalyzes the reduction of various organic hydroperoxides, as well as hydrogen peroxide, with glutathione (GSH) as hydrogen donor (2 GSH+H₂O₂→GS-GS+2H₂O). It has a molecular weight of 84,000 and consists of 4 subunits. The enzyme is useful for enzymatic determination of lipid hydroperoxide.

GI-GPx belongs to the family of selenoproteins and plays an important role in the defense mechanisms of mammals, birds and fish against oxidative damage by catalyzing the reduction of a variety of hydroperoxides, using glutathione as the reducing substrate. It has been suggested that this enzyme functions in more times as a mechanism of protecting the cellular membrane system against peroxidative damage and that selenium as an essential trace element which may play an important role in this suggested function of the enzyme. It is known that both vitamin E and Se act as antioxidants also in a common mechanism of oxidative stress as an underlying cause of genetic changes.

Selenium functions within mammalian systems primarily in the form of selenoproteins. Selenoproteins contain selenium as selenocysteine and perform a variety of physiological roles. Seventeen selenoproteins have been identified: cellular or classical glutathione peroxidase; plasma (or extracellular) glutathione peroxidase; phospholipid hydroperoxide glutathione peroxidase; gastrointestinal glutathione peroxidase; selenoprotein P; types 1, 2, and 3 iodothyronine deiodinase; selenoprotein W; thioredoxin reductase; and selenophosphate synthetase. Of these, cellular and plasma glutathione peroxidase are the functional parameters used for the assessment of selenium status (D. H. Holben, A. M. Smith, J. Am. Diet. Assoc. 1999, 99, 836-843).

Beside vitamin E (DL-α-tocopherol), vitamin C (L-ascorbic acid), co-enzyme Q10, zinc, and selenium a lot of further antioxidants such as N-acetyl-L-cycteine, N-acetyl-S-farnesyl-L-cysteine, Bilirubin, caffeic acid, CAPE, catechin, ceruloplasmin, Coelenterazine, copper diisopropylsalicylate, deferoxamine mesylate, R-(−)-deprenyl, DMNQ, DTPA dianhydride, Ebselen, ellagic acid, (−)-epigallocatechin, L-ergothioneine, EUK-8, Ferritin, glutathione, glutathione monoethylester, α-lipoic acid, Luteolin, Manoalide, MCI-186, MnTBAP, MnTMPyP, morin hydrate, NCO-700, NDGA, p-Nitroblue, propyl gallate, Resveratrol, rutin, silymarin, L-stepholidine, taxifolin, tetrandrine, tocopherol acetate, tocotrienol, Trolox®, U-74389G, U83836E, and uric acid (all available from Calbiochem, San Diego, Calif., U.S.A.) which can be applied for preventing and/or treating HCV infections by compensating at least partially the down-regulation of GI-GPx.

Further antioxidants may be selected from the group of carboxylic acids such as citric acid and phenolic compounds such as BHA (butylated hydroxyanisole), BHT (butylated hydroxytoluene), propyl gallate, TBHQ (tert-butyl hydroquinone), tocopherols, lecithin, gums and resin guiac, THBP (trihydroxybutyrophenone), thiodipropionic acid and dilauryl thiodipropionate, and glycines.

Oxidative damage is mainly caused by free radicals, particularly reactive oxygen intermediates, derived from normal cellular respiration and oxidative burst produced when phagocytic cells destroy bacteria or virus-infected cells. In order to cope with the constant generation of potentially damaging oxygen radicals, eukaryotic organisms have evolved many defense mechanisms. These include the above-mentioned antioxidants which act as free radicals scavengers and which may interact with GI-GPx and/or may activate, stimulate, and/or increase the expression and/or production of GI-GPx. This advantageous effect of the radicals on the amount of GI-GPx generated in the cells competes with the HCV-induced down-regulation of GI-GPx and supports the cells in their fight against the Hepatits C viruses.

HCV Infection Studies:

The only reliable experimental animal HCV infection studies have been performed with chimpanzees. So far, there is no simple cell culture infection system available or HCV. Although a number of reports have been published describing in vitro propagation attempts of HCV in primary cells and cell lines, questions remain concerning reproducibility, low levels of expression and properly controlled detection methods (reviewed in J. Gen Virol. 81, 1631; Antiviral Chemistry and Chemotherapy 10, 99). Thus, the replicon system described by Bartenschlager and coworkers (Lohmann et al, Replication of subgenomic hepatitis C virus RNAs in a hepatoma cell line. Science 285, 110. 1999) was used for the studies disclosed herein. This replicon system reproduces a crucial part of the HCV replication cycle which is used as a system for simulating HCV infection. Bartenschlager's group produced bicistronic recombinant RNAs, so-called “replicons”, which carry the neomycin-phosphotransferase (NPT) gene as well as a version of the HCV genome where the sequences for the structural HCV proteins were deleted. After transfection of the subgenomic HCV RNA molecules into the human hepatoma cell line HuH-7, cells supporting efficient RNA-dependent RNA replication of the HCV replicons were selected based on co-amplification of the NPT gene and resulting resistance to the antibiotic G-418. Integration of coding information into the cellular genome was an exclusion criteria for functional replicons. Several lines were established from G-418 resistant clones with autonomously replicating HCV RNAs detectable by Northern Blotting. Minus-strand RNA replication intermediates were detected by Northern Blotting or metabolic radio-labeling, and the production of nonstructural HCV proteins was demonstrated by immuno-precipitation after metabolic labeling or Western Blotting.

Possible influences and/or dependencies of HCV's RNA-dependent RNA replication and nonstructural proteins on host cell transcription are accessible to analysis with the Clontech cDNA arrays used in the methods described herein. HuH-pcDNA3 cells are HuH7 cells resistant to G-418 by integration of a NPT gene-carrying plasmid (pcDNA3, Invitrogen) and serve as negative control. Three replicon lines were analyzed for changes in cellular RNA expression patterns compared to the control line:
HuH-9-13: cell line with persistant replicon IRES377/NS3-3′/wt, described in Science 1999, 285, 110-113,
HuH-5-15: cell line with persistant replicon IRES389/NS3-3′/wt, described in Science 1999, 285, 110-113,
HuH-11-7: cell line with persistant replicon IRES377/NS2-3′/wt, described in Science 1999, 285, 110-113.

These HCV replicon cells serve as a system for simulation of HCV infected cell systems, especially for simulating HCV infected mammals, including humans. Interference of HCV with the cellular signaling events is reflected in differential gene expression when compared to cellular signaling in control cells. Results from this signal transduction microarray analysis revealed significant downregulation of GI-GPx. Radioactively labeled complex cDNA-probes from HCV Replicon cells HuH-9-13, HuH-5-15, and HuH-11-7 were hybridized to cDNA-arrays and compared to hybridizations with cDNA-probes from HuH-pcDNA control cells which did not contain HCV Replicons.

Based on the surprising results reported herein, one aspect of the present invention is directed to specific chemical substances and compounds useful for the prophylaxis and/or treatment of Hepatitis C virus infections. Specifically, these specific chemical substances and compounds comprise selenium, selenium salts, Vitamine D₃, pegylated and non-pegylated (standard) α-, β-, and γ-interferon, ribavirin, and retinoids, particularly all forms of retinoic acid, all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, like 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, 13-cis retinoic acid, salts of 13-cis retinoic acid, C₁-C₁₀ alkyl esters of 13-cis retinoic acid, salts of C₁-C₁₀ alkyl esters of 13-cis retinoic acid, C₁-C₁₀ alkyl amides of 13-cis retinoic acid, salts of C₁-C₁₀ alkyl amides of 13-cis retinoic acid as well as (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphtalenyl)carboxamido]benzoic acid (AM-580), N-(4-hydroxyphenyl)retinamide (4-HPR) and 6-[341-adamantyl)-4-hydroxyphenyl]-2-naphthalene carboxylic acid (CD437; AHPN).

The above mentioned chemical substances and compounds may be combined with further compounds like paraquat.

Furthermore, the present invention discloses a method for treating Hepatitis C virus infection in an individual. Preferably the individual is a non-responder to interferon and/or ribavirin therapy. The method comprises the step of administering a pharmaceutically effective amount of at least one of the specific chemical compounds and substances referred to above, which upregulate at least partially the activity of GI-GPx or which upregulate at least partially the production of GI-GPx in the cells. To the specific chemical compounds and substances the further compounds like all trans retinoic acid and paraquat may be added.

A similar aspect of the present invention is directed to a method for preventing and/or treating Hepatitis C virus infection and/or diseases associated with HCV infection in cells or cell cultures comprising the step of administering a pharmaceutically effective amount of at least one of the specific chemical compounds and substances referred to above, which upregulate at least partially the activity of GI-GPx or which upregulate at least partially the production of GI-GPx.

Another aspect of the present invention is to provide a method for regulating the production of Hepatitis C virus in an individual or In cells or cell cultures comprising the step of administering a pharmaceutically effective amount of at least one of the specific chemical compounds and substances referred to above, which at least partially upregulate the activity GI-GPx or which at least partially upregulate the production of GI-GPx in the cells. Preferably, the individual is a non-responder to interferon and/or ribavirin therapy.

In addition to the above-mentioned methods the present invention is also directed to a method for preventing and/or treating Hepatitis C virus infection and/or diseases associated with HCV infection in an individual comprising the step of administering a pharmaceutically effective amount of at least one of the specific chemical compounds and substances referred to above, which activates at least partially GI-GPx or which activates or stimulates the production of GI-GPx in the individual. Again, preferably the individual is a non-responder to interferon and/or ribavirin therapy.

Another inventive aspect is related to a method for preventing and/or treating Hepatitis C virus infection and/or diseases associated with HCV infection in cells or cell cultures comprising the step of administering a pharmaceutically effective amount of at least one of the specific chemical compounds and substances referred to above, which activate at least partially the activity of GI-GPx or which activate or stimulate at least partially the production of GI-GPx.

The term “associated diseases” refers to, for instance, opportunistic infections, liver cirrhosis, liver cancer, hepatocellular carcinoma, or any other diseases that can come along with HCV infection.

The function of GI-GPx is to detoxify peroxides in cells and protect the cells from oxidative damage. Subjecting HCV infected cells to oxidative stress conditions, preferably induced by paraquat or radicals generated from peroxides, leads to a decreased resistance of HCV infected cells in comparison to uninfected cells against toxicity of radicals. Thus, generating artificial oxidative stress conditions allows selective killing of HCV-infected cells.

Examples for useful radical forming compounds (radical initiators) are bipyridyls such as paraquat, 2,2′-bipyridyl and 4,4′-bipyridyl derivatives, bis-6-(2,2′-bipyridyl)-pyrimidines, tris-(2,2′-bipyridyl)ruthenium, peroxides such as dibenzoylperoxid, diacetylperoxide, hydrogen peroxide, di-tert.-butylperoxide, or diaza compounds such as diazaisobutyronitril.

Yet another aspect of the present invention is directed to a novel therapeutic composition useful for the prophylaxis and/or treatment of an individual afflicted with Hepatitis C virus and/or associated diseases comprising at least one of the specific chemical substances and compounds selected from the group consisting of selenium, selenium salts, Vitamin D₃, pegylated and non-pegylated (standard) α-, β-, and γ-interferon, ribavirin, and retinoids, particularly all isomeric forms of retinoic acid, like all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, 13-cis retinoic acid, salts of 13-cis retinoic acid, C₁-C₁₀ alkyl esters of 13-cis retinoic acid, salts of C₁-C₁₀ alkyl esters of 13-cis retinoic acid, C₁-C₁₀ alkyl amides of 13-cis retinoic acid, salts of C₁-C₁₀ alkyl amides of 13-cis retinoic acid, as well as (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphtalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (CD437; AHPN). A preferred selenium salt is sodium selenite. Moreover, according to a further aspect of the present invention, the composition may contain a certain amount of all trans retinoic acid and paraquat. The preferred individual is a non-responder to interferon and/or ribavirin therapy.

Further embodiments of the present Invention are represented by methods for regulating the production of Hepatitis C virus in an individual or in cells or cell cultures comprising the step of administering an individual or the cells a pharmaceutically effective amount of at least one of the specific chemical substances and compounds selected from the group consisting of selenium, selenium salts, Vitamin D₃ and retinoids, like all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, 4-[E-2-(5,6,7,8-tetrahydro-5,5,8,8-tetra-methyl-2-naphthalenyl)-1-propenyl]benzoic acid, and/or 4-(5,6,7,8-tetrahydro-5,5,8,8-tetramethyl-2-naphthalenyl)carboxamido benzoic acid, N-(4-hydroxyphenyl) retinamide (4-HPR), and 6-[3-1-adamantyl)-4-hydroxyphenyl]-2-naphthalene carboxylic acid (CD437; AHPN), wherein said substance or compound activates or increases at least partially the activity of said human cellular protein glutathione peroxidase-gastrointestinal or wherein said agent at least partially activates or stimulates the production of said human cellular protein glutathione peroxidase-gastrointestinal. The above mentioned chemical substances and compounds may be combined with further compounds like all trans retinoic acid and paraquat. Preferably, the individual is a non-responder to interferon and/or ribavirin therapy.

Another aspect of the present invention is directed to novel therapeutic compositions useful within said methods for prophylaxis and/or treatment of an individual afflicted with Hepatitis C virus and/or associated diseases. Said compositions comprise at is least one of the specific chemical substances and compounds selected from the group consisting of selenium, selenium salts, Vitamin D₃ and retinoids, like all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, 4-[E-2-(5,6,7,8-tetrahydro-5,5,8,8-tetra-methyl-2-naphthalenyl)-1-propenyl]benzoic acid, and/or 4-(5,6,7,8-tetrahydro-5,5,8,8-tetramethyl-2-naphthalenyl)carboxamido benzoic acid, N-(4-hydroxyphenyl)retinamide (4-HPR), and 6-[3-1-adamantyl)-4-hydroxyphenyl]-2-naphthalene carboxylic acid (CD437; AHPN), capable of increasing the activity of GI-GPx or of activating or stimulating the production and/or expression of GI-GPx. Preferred individuals are non-responders to interferon and/or ribavirin therapy.

According to still further aspect of the present invention, the novel therapeutic compositions contain from 0.01 to 0.15% by weight, particularly from 0.02 to 0.05% by weight of the specific chemical substances and compounds or “agent(s)”. The above mentioned chemical substances and compounds may be combined with further compounds like all trans retinoic acid and paraquat.

Said pharmaceutical compositions may further comprise pharmaceutically acceptable carriers, excipients, and/or diluents.

In case the pharmaceutical composition is for oral application, according to a further embodiment of the present invention, the therapeutic agent (or agents) is (are) administered in the form of tablets or capsules. Such tablets or capsules may contain from 1 to 300 mg, preferably from 1 to 150 mg, more preferably from 1 to 100 mg, and particularly from 1 to 50 mg of the agent or agents.

Another possible way of applying a therapeutically effective amount of at least one of the above-mentioned specific substances to an individual (patient) is by means of including the substance(s) into liposomes and administering the liposomes to the individual. Liposomes are spherical particles having typically a diameter of about 25 nm to about 5 μm. Liposomes usually comprise one or more concentric lipid double layers having an aqueous interior compartment (so-called “lipid vesicles”). Liposomes are known as carriers for pharmaceutical substances, which can be selectively enriched in certain organs and cellular tissues by means of the liposomes, see e.g. Adv. Drug Deliv. Rev. 19, 425 to 444 (1996) and Science 267, 1275 et seq. (1995).

As used herein, the term “activator” refers to any chemical compound capable of upregulating, activating, stimulating, or increasing the amount and/or activity of GI-GPx or its expression.

As used herein, the term “inhibitor” refers to any compound capable of downregulating, decreasing, inactivating, suppressing or otherwise regulating the amount and/or activity of GI-GPx or its expression. Generally, GI-GPx inhibitors may be proteins, oligo- and polypeptides, nucleic acids, such as RNAi, genes, small chemical molecules, or other chemical moieties.

The term “agent” is used herein as synonym for regulator, inhibitor, and/or activator. Thus, the term “agent” refers to any chemical or biological compound capable of down- or upregulating, de- or increasing, suppressing or stimulating, inactivating or activating, or otherwise regulating or effecting the amount and/or activity of GI-GPx and/or the expression of GI-GPx.

In addition to the role In transmitting genetic information from DNA to proteins, RNA molecules participate actively in many cell processes. Examples are found in translation (rRNA, tRNA, tmRNA), intracellular protein targeting (SRP), nuclear splicing of pre-mRNA (snRNPs), mRNA editing (gRNA), and X-chromosome inactivation (Xist RNA). Each of these RNA molecules acts as a functional product in its own right, without coding any protein. Because RNA molecules can fold into unique shapes with distinct structural features, some RNAs bind to specific proteins or small molecules (as in the ATP-binding aptamer), while others catalyze particular chemical reactions. Thus, RNA aptamers can be used to interact with GI-GPx and thereby modulate, regulate, activate, or inhibit the activity and biological function of said peroxidase.

As used herein, the term “regulating expression and/or activity” generally refers to any process that functions to control or modulate the quantity or activity (functionality) of a cellular component. Static regulation maintains expression and/or activity at some given level. Upregulation refers to a relative increase in expression and/or activity. Accordingly, downregulation refers to a relative decrease in expression and/or activity. Downregulation is synonymous with inhibition of a given cellular component's activity.

Further aspects of the present invention relate to methods either for regulating the expression of the human cellular protein glutathione peroxidase-gastrointestinal in an Individual or in cells or cell cultures comprising the step of administering either the individual or the cells or cell cultures a pharmaceutically effective amount of an agent wherein said agent inhibits or decreases at least partially the transcription of DNA and/or the translation of RNA encoding said human cellular protein glutathione peroxidase-gastrointestinal. Again, preferred individuals are non-responders to interferon and/or ribavirin therapy.

Therapeutics, pharmaceutically active agents or inhibitors, respectively, may be administered to cells from an individual in vitro, or may involve in vivo administration to the individual. The term “individual” preferably refers to mammals and most preferably to humans. Humans particularly preferred are non-responders to interferon and/or ribavirin therapy. Routes of administration of pharmaceutical preparations to an individual may Include oral and parenteral, including dermal, intradermal, intragastral, intracutan, intravasal, intravenous, intramuscular, intraperitoneal, intranasal, intravaginal, intrabuccal, percutan, rectal, subcutaneous, sublingual, topical or transdermal application, but are not limited the these ways of administration. For instance, the preferred preparations are in administratable form which is suitable for oral application. These administratable forms, for example, include pills, tablets, film tablets, coated tablets, capsules, powders and deposits. Administration to an individual may be in a single dose or in repeated administrations, and may be in any of a variety of physiologically acceptable salt forms, and/or with an acceptable pharmaceutical carrier, binder, lubricant, excipient, diluent and/or adjuvant. Pharmaceutically acceptable salt forms and standard pharmaceutical formulation techniques are well known to persons skilled in the art.

As used herein, a “pharmaceutical effective amount” of a GI-GPx activator is an amount effective to achieve the desired physiological result, either in cells or cell cultures treated in vitro or in a subject (e.g. individual, particularly human being) treated in vivo. Specifically, a pharmaceutically effective amount is an amount sufficient to inhibit, for some period of time, one or more of the clinically defined pathological processes associated with the viral infection. The effective amount may vary depending on the specific GI-GPx inhibitor or activator selected, and is also dependent on a variety of factors and conditions related to the subject to be treated and the severity of the infection. For example, if the activator is to be administered in vivo, factors such as the age, weight and health of the patient as well as dose response curves and toxicity data obtained in pre-clinical animal work would be among those considered. If the activator is to be contacted with the cells or cell cultures in vitro, one would also design a variety of pre-clinical in vitro studies to assess such parameters as uptake, half-life, dose, toxicity, etc. The determination of a pharmaceutically effective amount for a given agent is well within the ability of those skilled In the art. As mentioned above, a “therapeutically effective amount” of the substances and compounds according to the present invention may be 0.01 to 0.15% by weight of a pharmaceutical composition. In case a tablet or capsule is used as administrative form, the amount of the effective substance or compound in the tablet or capsule may be 1 to 300 mg, preferably 1 to 150 mg, more preferably 1 to 100 mg, and particularly 1 to 50 mg.

The present disclosure teaches for the first time the upregulation of GI-GPx specifically involved in the viral infection of Hepatitis C virus using specific chemical compounds and substances selected from the group consisting of selenium, selenium salts, Vitamin D₃, pegylated and non-pegylated (standard) α-, β-, and γ-interferon, ribavirin, and retinoids, particularly all isomeric forms of retinoic acid, like all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, 13-cis retinoic acid, salts of 13-cis retinoic acid, C₁-C₁₀ alkyl esters of 13-cis retinoic acid, salts of C₁-C₁₀ alkyl esters of 13-cis retinoic acid, C₁-C₁₀ alkyl amides of 13-cis retinoic acid, salts of C₁-C₁₀ alkyl amides of 13-cis retinoic acid, as well as 4-[E-2-(5,6,7,8-tetrahydro-5,5,8,8-tetra-methyl-2-naphthalenyl)-1-propenyl]benzoic acid, and/or 4-(5,6,7,8-tetrahydro-5,5,8,8-tetramethyl-2-naphthalenyl)carboxamido benzoic acid, N-(4-hydroxyphenyl)retinamide (4-HPR), and 6-[3-(1-adamantyl)-4-hydroxyphenyl]-2-naphthalene carboxylic acid (CD437; AHPN). The above mentioned chemical substances and compounds may be combined with further compounds like all trans retinoic acid and paraquat.

The polypeptide product of gene expression may be assayed to determine the amount of expression as well. Methods for assaying for a protein include, but are not limited to, Western Blotting, immuno-precipitation, radioimmuno assay, immunohistochemistry and peptide immobilization in an ordered array. It is understood, however, that any method for specifically and quantitatively measuring a specific protein or mRNA product can be used.

The present invention further incorporates by reference in their entirety techniques well known in the field of microarray construction and analysis. These techniques include, but are not limited to, techniques described in the following patents and patent applications describing array of biopolymeric compounds and methods for their fabrication:
U.S. Pat. Nos. 5,242,974; 5,384,261; 5,405,783; 5,412,087; 5,424,186; 5,429,807; 5,436,327; 5,445,934; 5,472,672; 5,527,681; 5,529,756; 5,545,531; 5,554,501; 5,556,752; 5,561,071; 5,559,895; 5,624,711; 5,639,603; 5,658,734; 5,807,522; 6,087,102; WO 93/17126; WO 95/11995; WO 95/35505; EP 742 287; and EP 799 897.

Techniques also include, but are not limited to, techniques described in the following patents and patent application describing methods of using arrays in various applications:
U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,994,076; 6,033,860; 6,040,138; 6,040,140; WO 95/21265; WO 96/31622; WO 97/10365; WO 97/27317; EP 373 203; and EP 785 280

A robust cell culture system for the hepatitis C virus (HCV) has not been established. For this reason, it is extremely difficult to study how HCV infects cells and to test anti-viral drugs in a model system (the only animals that can be infected are humans and chimpanzees). A major step in devising a culture system for HCV was established by the replicon cell lines (Lohmann, V., Korner, F., Koch, J.-O., Herian, U., Theilmann, L., and Bartenschlager, R. 1999. Replication of subgenomic hepatitis C virus RNAs in a hepatoma cell line. Science. 285: 110-113). Replication of subgenomic HCV RNAs in cultured hepatocytes were obtained for the first time. These subgenomic replicons are composed of only the part of the HCV genome that encodes the non-structural proteins but are competent to be replicated in cells and synthesize viral proteins. The replicons described in the scientific article of Lohmann et al. cited above and used for the present investigation allows studies of HCV replication, pathogenesis and evolution in cell culture. They may also allow for cell-based testing of certain types of anti-viral drugs.

Recently, gastrointestinal-glutathione peroxidase (GI-GPx) could be validated as target in HCV-replication (see WO 02/084294). As mentioned above, GI-GPx belongs to the family of selenoproteins and plays an important role in the defense mechanisms of eucaryotic cells against oxidative damage by catalyzing the reduction of a variety of hydroperoxides, using glutathione as the reducing substrate. It has been suggested that this enzyme functions as a mechanism of protecting the cellular membrane system against peroxidative damage. Selenium as a necessary trace element suggests the essential function of this enzyme.

Selenium functions within mammalian systems primarily in the form of selenoproteins. Selenoproteins contain selenium as selenocysteine and perform a variety of physiological roles. Seventeen selenoproteins have been identified: cellular or classical glutathione peroxidase; plasma (or extracellular) glutathione peroxidase; phospholipid hydroperoxide glutathione peroxidase; gastrointestinal glutathione peroxidase; selenoprotein P; types 1, 2, and 3 iodothyronine deiodinase; selenoprotein W; thioredoxin reductase; and selenophosphate synthetase. Of these, cellular and plasma glutathione peroxidase are the functional parameters used for the assessment of selenium status (D. H. Holben, A. M. Smith, J. Am. Diet. Assoc. 1999, 99, 836-843).

GI-GPx is drastically down-regulated in HCV replicon cells compared with mock-transfected HuH7 cells. Forcing replicon cells to re-express GI-GPx (e.g. by infection with GI-GPx containing Adenovirus) results in reduction of subgenomic HCV RNA and of the HCV protein NS5a to hardly detectable levels (see WO 02/084294). According to the present invention the knowledge of this inverse correlation was used to develop a method to up-regulate the expression of the cellular, endogenous GI-GPx gene. This up-regulation in replicon cells causes a depletion of HCV.

It is readily apparent to those skilled in the art that other suitable modifications and adaptations of the compositions and methods of the invention described herein are evident and may be made without departing from the scope of the invention or the embodiments disclosed herein. Having now described the present invention in detail, the same will be more clearly understood by reference to the following examples, which are included for purposes of illustration only and are not intended to limit the invention.

### EXAMPLES

Reference is Made to the Examples of WO 02/084294, which are Incorporated herein by Reference.

Moreover, as model system for HCV replication there were utilized three replicon cell lines provided by Prof. R. Bartenschlager (University of Heidelberg, FRG). Cultures were treated for various periods of time with all bans retinoic acid (RA) for comparative purposes and the other agents selenium, selenium salts, Vitamin D₃ and retinoids, like 9-cis retinoic acid, C₁-C₁₀ alkyl esters of 9-cis retinoic acid, C₁-C₁₀ alkyl amides of 9-cis retinoic add, N-(4-hydroxyphenyl)retinamide (4-HPR) and 6-[3-(1-adamantyl)+hydroxyphenyl]-2-naphthalene carboxylic acid (CD437; AHPN) (obtained from Sigma). Levels of expression of GI-GPx was measured on protein level by Western Blotting using antibodies provided by Prof. Brigelius-Flohe (University of Potsdam, FRG) and on RNA level by Northern blotting using GI-GPx-specific oligonucleotides as probes. Levels of HCV RNA were investigated by Northern Blotting using a DNA oligonucleotide complementary to the neomycin phosphotansferase gene as probe. Concentration of the viral protein NS5a was determined by Western Blotting with an NS5a-specific antibody (Biogenesis, UK).

Treatment of replicon cells for three days with all trans retinoic acid (1 μM) had hardly an effect on GI-GPx and HCV expression. However, after seven days of incubation, a drastic up-regulation of GI-GPx on RNA- and protein level (three- to ten-fold) was observed. Concomitantly expression of subgenomic HCV RNA and of viral protein NS5a was downregulated two- to five-fold, depending on the cell line investigated. Furthermore, surprisingly it was found that a further downregulation of HCV-RNA and -NS5a protein was dependent on the addition of selenium or a selenium salt, e.g. sodium selenite (50 nM). This fact implies, that downregulation of HCV was promoted firstly by activation of the GI-GPx gene on transcriptional level by retinoic acid and secondly by the synthesis of selenoprotein(s) for which sodium selenite was needed. Indeed it could be shown that all trans retinoic acid-induced downregulation of HCV is independent of the innate immune response induced by interferon. Thus, all trans retinoic acid did not induce the transcription of PKR (double strand RNA-dependent protein kinase). Severe cytotoxic effects were neither observed for all trans retinoic acid nor for sodium selenite, or both in combination.

The presented findings show that retinoids (in combination with selenium or selenium salts like sodium selenite and/or CAMP and/or analogues thereof) can be used for the treatment of HCV-positive patients. Especially the usage of retinoids with high specificity for induction of the GI-GPx, like N-(4-hydroxyphenyl) retinamide (4-HPR) and 6-[3-1-adamantyl)-4-hydroxyphenyl]-2-naphthalene carboxylic acid (CD437; AHPN), are preferred. 4-HPR and AHPN display significant potential as therapeutic agents in the prophylaxis and treatment of a number of premalignant and malignant conditions in the context of HCV infections. Indeed, the obtained data show that next to all trans retinoic acid other nuclear receptor ligands, like 9-cis retinoic acid as well as salts thereof, 9-cis retinoic acid C₁ to C₁₀ alkyl esters as well as salts therof, 9-cis retinoic acid C₁ to C₁₀ alkyl amides as well as salts therof, and Vitamin D₃, are also capable of reducing HCV load.

All-trans retinoic acid on replicon cells for six days led to an upregulation of GI-GPx RNA and protein due to the fact that the GI-GPx-promoter contains three retinoic acid receptor recognition elements. In the presence of selenium or a selenium salt like sodium selenite a two- to five-fold reduction of HCV-RNA and HCV-NS5a protein was observed in the absence of toxic effects. Moreover, also the specific retinoids, like N-(4-hydroxyphenyl)retinamide (4-HPR) and 6-[3-(1-adamantyl)-4-hydroxyphenyl]-2-naphthalene carboxylic acid (CD437; AHPN), 9-cis retinoic acid, 9-cis retinoic acid C₁ to C₁₀ alkyl esters, 9-cis retinoic acid C₁ to C₁₀ alkyl amides, and Vitamin D₃ alone or in combination with each other or with selenium or a selenium salt showed a similar effect.

Moreover, first preliminary result have shown that 9-cis retinoic acid and its above-mentioned alkyl and amide derivates downregulate HCV RNA significantly better than all trans retinoic acid alone.

The following examples describing administrative forms for a lotion (solution), gel, cream, soft gelatin capsules, hard gelatine capsules, tablets, and sachets containing 9-cis retinoic acid are taken from U.S. Pat. No. 5,428,071 and EP-B1-0 552 624.

### Example 1

| Lotion (solution) | | | preferred | |
|---|---|---|---|---|
| 9-cis-Retinoic Acid | 0.02-0.30 | g | | |
| Propylene Glycol | 5.00-20.00 | g | 10.00 | g |
| PEG-Glyceryl Cocoate* | 0.00-20.00 | g | 10.00 | g |
| dl-alpha-Tocopherol | 0.001-0.50 | g | 0.02 | g |
| Ascorbyl Palmitate | 0.01-0.20 | g | 0.10 | g |
| Propyl Gallate | 0.001-0.02 | g | 0.002 | g |
| Citric acid, anhydr** | 0.00-0.20 | g | 0.01 | g |
| Isopropanol*** | 40.00-90.00 | g | 50.00 | g |
| Water, dem. ad | 100.00 | g | 100.00 | g (resp. ml) |

*or other tensides
**or other complexing agents, e.g. EDTA
***or other alcohols, e.g. Ethanol

### Example 2

| Gel | | | preferred | |
|---|---|---|---|---|
| 9-cis-Retinoic Acid | 0.02-0.30 | g | | |
| Propylene Glycol | 5.00-20.00 | g | 10.00 | g |
| PEG-Glyceryl Cocoate* | 0.00-20.00 | g | 10.00 | g |
| dl-alpha-Tocopherol | 0.001-0.50 | g | 0.02 | g |
| Ascorbyl Palmitate | 0.01-0.20 | g | 0.10 | g |
| Propyl Gallate | 0.001-0.02 | g | 0.002 | g |
| Citric acid, anhydr** | 0.00-0.20 | g | 0.01 | g |
| Isopropanol*** | 40.00-90.00 | g | 50.00 | g |
| HPMC**** | 0.50-5.00 | g | 3.0 | g |
| Preservative***** | q.s. | | q.s. | |
| Water, dem. ad | 100.00 | g | 100.00 | g |

*or other tensides
**or other complexing agents, e.g. EDTA
***or other alcohols, e.g. Ethanol
****Hydroxypropyl Methylcellulose or other polymers e.g. neutralized Carbomer, Methyl Cellulose, Sodium Carboxymethylcellulose
*****Preservatives, e.g. Paraben esters (methyl, ethyl, propyl, butyl), Sorbic Acid, Benzoic, Acid

### Example 3

| Cream | | | preferred | |
|---|---|---|---|---|
| 9-cis-Retinoic Acid | 0.02-0.30 | g | | |
| Glycerol | 0.00-10.00 | g | 5.00 | g |
| Na.sub.2 EDTA | 0.001-0.50 | g | 0.03 | g |
| Glycerides* | 5.00-20.00 | g | 10.00 | g |
| Cetyl Alcohol | 0.50-5.00 | g | 1.00 | g |
| Stearyl Alcohol | 0.50-5.00 | g | 1.00 | g |
| Glycerol mono Stearate | 1.00-8.00 | g | 4.00 | g |
| Cetaereth** | 0.50-5.00 | g | 2.00 | g |
| dl-alpha-Tocopherol | 0.001-0.50 | g | 0.02 | g |
| Preservative*** | q.s. | | q.s. | |
| Water, dem. ad | 100.00 | g | 100.00 | g |

*e.g. Caprylic/Capric/Triglyceride, Caprylic/Capric/Linoleic Triglyceride natural glycerides, as well as e.g., Propylene Glycol, Dicaprylate/Dicaprate and waxes such as Stearyl Stearate, Oleyl Oleate, Isopropyl Myristate.
**Ceteareth 5-30, or other emulsifiers such as Polysorbate 20-80, Sorbitane esters of fatty acids, fatty acid esters of PEG.
***Preservatives e.g., Paraben esters (methyl, ethyl, propyl, butyl), Sorbic Acid, Benzoic Acid.

### Example 4

Fill mass for soft gelatin capsules

| | | |
|---|---|---|
| 9-cis-Retinoic Acid | 5.00-50.00 | mg |
| Oil* | 1-3 | parts |
| Wax mixture** | 1-5 | parts |
| Fill volume | 1-6 | minims |

*natural vegetable oils, e.g., soy oil, peanut oil, and artificial glycerides
**composition of natural and artificial waxes or partially hydrated fa

### Example 5

1. Hard Gelatine capsules containing 20 mg active substance:

Composition: One Capsule contains:

| | | |
|---|---|---|
| 9-cis-Retinoic acid | 20.0 | mg. |
| Gelatine Bloom 30 | 70.0 | mg. |
| Maltodextrin MD 05 | 108.0 | mg. |
| dl-alpha-Tocopherol | 2.0 | mg. |
| Sodium ascorbate | 10.0 | mg. |
| Microcrystalline cellulose | 48.0 | mg. |
| Magnesium stearate | 2.0 | mg. |
| (weight capsule content) | 260.0 | mg. |

Procedure:
The active substance is wet milled in a solution of gelatine,
maltodextrin, dl-alpha-Tocopherol and sodium ascorbate.
The wet milled suspension is spray-dried.
The spray-dried powder is mixed with microcrystalline cellulose
and magnesium stearate.
260 mg. each of this mixture are filled into hard gelatine capsules
of suitable size and color.

### Example 6

2. Tablet containing 20 mg active substance:

Composition:

| Tablet kernel: | | |
|---|---|---|
| 9-cis-Retinoic acid | 20.0 | mg |
| Anhydrous lactose | 130.5 | mg |
| Microcrystalline Cellulose | 80.0 | mg |
| dl-alpha-Tocopherol | 2.0 | mg |
| Sodium ascorbate | 10.0 | mg |
| Polyvinylpyrrolidone K30 | 5.0 | mg |
| Magnesium stearate | 2.5 | mg |
| (Kernel weight) | 250.0 | mg |
| Film coat: | | |
| Hydroxypropyl methylcellulose | 3.5 | mg |
| Polyethylenglycol 6000 | 0.8 | mg |
| Talc | 1.3 | mg |
| Iron oxide, yellow | 0.8 | mg |
| Titanium dioxide | 0.8 | mg |
| (weight of the film) | 7.4 | mg |

Procedure:
9-cis-Retinoic acid is mixed with anhydrous lactose and micro-
crystalline cellulose.
The mixture is granulated in water with a solution/dispersion of
polyvinylpyrrolidone, dl-.alpha.-Tocopherol and sodium ascorbate.
The granular material is mixed with magnesium stearate and
afterwards pressed as kernels with 250 mg. weight.
The kernels are film coated with a solution/suspension of
above-mentioned composition.

### Example 7

Sachet Containing 50 mg Active Substance

Composition:

| | | |
|---|---|---|
| 9-cis-Retinoic acid | 50.0 | mg |
| Lactose, fine powder | 990.0 | mg |
| Microcrystalline Cellulose | 1400.0 | mg |
| Sodium Carboxymethyl-cellulose | 14.0 | mg |
| dl-alpha-Tocopherol | 5.0 | mg |
| Sodium ascorbate | 20.0 | mg |
| Polyvinylpyrrolidone K30 | 10.0 | mg |
| Magnesium stearate | 10.0 | mg |
| Flavouring Agents | 1.0 | mg |
| (Fill weight of a sachet) | 2500.0 | mg |

Procedure:
9-cis-Retinoic acid is mixed with lactose, microcrystalline cellulose
and sodium carboxymethyl cellulose.
The mixture is granulated in water with a solution/dispersion of
polyvinylpyrrolidone, dl-alpha-Tocopherol and sodium ascorbate.
The granule is mixed with magnesium stearate and flavoring
agents.
It is filled into sachets of suitable size.

In the following, results of tests are presented relating to retinoic acid and derivatives thereof for treatment of HCV infected cells non-responding to interferon treatment.

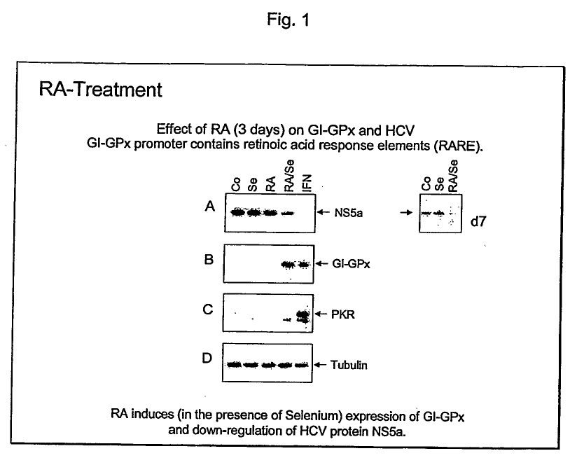

Treating the HCV replicon cell lines with all trans retinoic acid (ATRA), or some derivatives thereof, resulted in suppression of HCV RNA and of NS5a protein expression (FIG. 1, Panel A). Many findings demonstrate that the underlying mechanism is due to the up-regulation of the selenocystein protein gastrointestinal glutathione peroxidase (GI-GPx) gene (FIG. 1, Panel B). E.g., this effect was most prominent when sodium selenite (50 nM) was given to the cell culture medium (FIG. 1, Panel A), which is needed for the synthesis and thus up-regulation of the GI-GPx protein (FIG. 1, Panel B).

Retinoic acid (RA)- and Interferon (IFN)-Dependent Pathways

In the course of retinoic acid studies it was investigated whether the RA-effect may also be mediated by activating an interferon response. A typical interferon-inducible gene codes for the double-stranded RNA-dependent protein kinase (PKR). Mock-transfected HuH7 cells (pcDNA3) and replicon cell lines were treated with ATRA (1 μM), but no up-regulation of the PKR mRNA levels monitored by Northern blotting was observed. IFN as a control, however, caused a dramatic up-regulation of PKR mRNA. An example for a replicon cell line is shown in FIG. 1, Panel C.

These results show that RA acts independently of IFN on the replicon system. These results furthermore imply that HCV-patients, who do not react on IFN treatment, so called non-responders, may be cured by RA-treatment.

Unfortunately, there is no IFN-resistant replicon system described in the literature to test this hypothesis directly.

Effect of RA in Combination with IFN

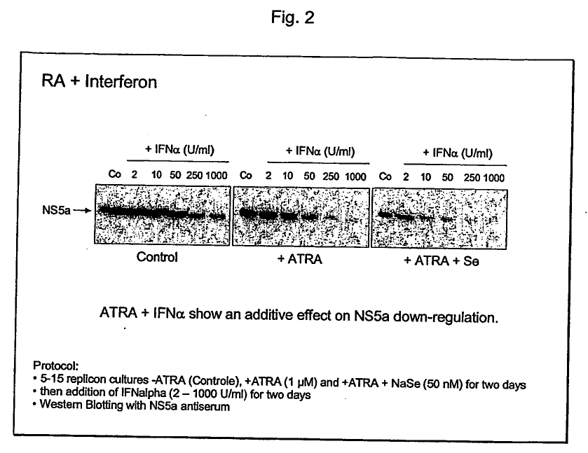

In a recent publication (Retinoic acid enhances the antiviral effect of interferon on hepatitis C virus replication through increased expression of type I interferon receptor. Hamamoto et al., J. Lab. Clin. Med. 141, 2003, 58-66) it is asserted that treating HuH7 cells with ATRA and 9-cis RA induces the expression of Interferon Type I receptor subunits (max. 2-fold after 24 hrs on RNA level, TaqMan analysis). Interestingly, this effect was independent of the dose (FIG. 2 of the article by Hamamoto cited above). IFN treatment decreased the concentration of transfected HCV (replicon-) RNA, and this effect was enhanced by treatment with RAs. The authors conclude that RAs increase the anti-HCV replication effect of IFN-alpha through up regulation of type I IFN-receptor in HuH-7 cells.

The expression of interferon receptors after treatment of replicon cells with ATRA was analyzed by western Blotting, but no up-regulation of interferon receptors on protein level was observed.

When using sub-therapeutic concentrations of IFN alpha, we found a dose-dependent reduction of the HCV protein NS5a (FIG. 2, left Panel). In the presence of RA, the HCV down-regulation was slightly enhanced (center Panel). The strongest effect was observed, when IFN was applied with ATRA and sodium selenite together (FIG. 2, right Panel).

The data show that the IFN and RA-effects are additive and imply that their mechanisms to down-regulate HCV are independent. This finding further substantiates the hypothesis that RA can act in IFN-resistant patients (non-responders).

Comparing the results presented by Hamamoto with the results described herein reveals the following:

Both groups come to the same conclusion, namely that IFN and RA promote additive anti-HCV effects. However, while Hamamoto asserts that the RA effect is due to the up-regulation of IFN Type I receptor (a finding which could not be reproduced), according to the present invention it is believed that the RA-effect is due to the up-regulation of GI-GPx.

Furthermore, the ability of several retinoids (i.e. all trans retinoic acid (ATRA); 9-cis retinoic acid (9-cis RA); 13-cis retinoic acid (13-cis RA); (E)-4-[2-(5,6,7,8-tetrahydro-5,5,8,8-tetramethyl-2-naphthalenyl-1-propenyl]benzoic acid (TTNPB); (4-[5,6,7,8-tetrahydro-5,5,8,8-tetramethyl-2-naphtalenyl)carbox-amido]benzoic acid (AM-580); and N-(4-hydroxyphenyl)retinamide (4-HPR)) to act as ligands for nuclear receptors (RAR=Retinoic Acid Receptor; RXR=Retinoid X Receptor) was tested and compared with a non retinoid substance (11-methoxy-3,7,11-trimethyl-2E,4E-dodecadienoic acid=methoprene acid). The results are shown in the following Table 1.

TABLE 1

| Ligand | Receptor(s) | Effect on Replication |
|---|---|---|
| ATRA | RAR (Kd* = 0.2-0.4 nM) | +++ |
| 9-cis RA | RAR, RXR | +++ |
| 13-cis RA | RAR, RXR | +++ |
| TTNPB | RAR (EC₅₀** = 2-21 nM) | +++ |
| 4-HPR | RAR | ++ |
| AM-580 | RARα/not RXR | ++ |
| Methoprene acid | RXR | − |

*Kd = dissociation constant
**EC₅₀ = effector concentration (concentration showing 50% effect)
+++ = very strong inhibitory effect;
++ = medium inhibitory effect;
− = no inhibitory effect

The data imply that RARs, but not RXRs are involved in up-regulation of the glutathione peroxidase-gastrointestinal (GI-GPx) promoter. The data furthermore show that inhibition of HCV replication was linked to up-regulation of GI-GPx mRNA.

Preliminary studies have shown that retinoic acids (e.g. Vesanoid®, Roche Pharmaceuticals, Nutley, N.J., USA) or retinoids may be administered to a patient in amount of about 1 to 100 mg/m²/day, preferably 20 to 80 mg/m²/day, more preferably 30 to 60 mg/m²/day, and particularly 40 to 50 mg/m²/day. Suitable doses are 1 to 4 timer per day, preferably 1 to 3 times per day, and particularly 2 times a day.

If a combination therapy is applied, in addition to the retinoic acid or retinoid in the amounts mentioned above, an interferon (e.g. pegylated interferon α, e.g. Pegasys® (Hoffmann-La Roche)) may be administered in an amount of about 135 to 180 μg/week (preferably 1 dose per week).

Specifically preferred is a therapy with ATRA alone for the treatment of HCV infections of non responders. Moreover, the treatment with ATRA plus interferon (pegylated or non-pegylated α, β, or γ-interferon), ATRA plus interferon (pegylated or non-pegylated α, β, or γ-interferon) plus selenium or selenium salt, or ATRA plus selenium (and/or selenium salt) and ribavirin is particularly preferred.

1. A composition useful for the prophylaxis and/or treatment of an individual afflicted with a Hepatitis C virus (HCV) infection and/or at least one disease associated with a HCV infection, said composition comprising at least one agent selected from selenium, selenium salts, Vitamin D₃, all trans retinoic acid, salts of all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl) retinamide (4-HPR), and 6-[3-(1-adamantyl)-4-hydroxyphenyl]-2-naphthalene carboxylic acid (AHPN).

2. The composition according to claim 1, wherein the composition comprises from 0.01 to 0.15% by weight of the agent(s).

3. The composition according to claim 1, wherein the composition comprises from 0.02 to 0.05% by weight of the agent(s).

4. The composition according to claim 1, wherein the selenium salt is sodium selenite.

5. The composition according to claim 1, wherein the composition further comprises at least one of the following compounds: pegylated α-, β-, and/or γ-interferon, non-pegylated (standard) α-, β-, and/or γ-interferon, and ribavirin.

6. The composition according to claim 1, wherein the composition further comprises paraquat.

7. The composition according to claim 1, further comprising at least one pharmaceutically acceptable carrier, excipient and/or diluent.

8. The composition according to claim 1, wherein the individual afflicted with a HCV infection and/or at least one disease associated with HCV infection is a non-responder to interferon and/or ribavirin therapy.

9. A method for regulating the production of Hepatitis C virus in an individual and/or for preventing and/or treating Hepatitis C virus infection and/or diseases associated with HCV infection in an individual, the method comprising administering a pharmaceutical composition comprising a pharmaceutically effective amount of at least one agent selected from selenium, selenium salts. Vitamin D₃, all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ allyl amides of 9-cis retinoic acid, salts of C₁-C₁₀ alkyl amides of 9-cis retinoic acid, (E)-4-[2-(5,6,7,8-tetrahydro-5,5,8,8-tetramethyl-2-naphthalenyl-1-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (AHPN) to the individual.

10. The method according to claim 9, wherein the pharmaceutical composition comprises from 0.01 to 0.15% by weight of the agent(s).

11. The method according to claim 10, wherein the pharmaceutical composition comprises from 0.02 to 0.05% by weight of the agent(s).

12. The method according to claim 9, wherein the selenium salt is sodium selenite.

13. The method according to claim 9, wherein the pharmaceutical composition further comprises at least one of the following compounds: pegylated α-, β, and/or γ-interferon, non-pegylated (standard) α, β-, and/or γ-interferon, and ribavirin.

14. The method according to claim 9, wherein the pharmaceutical composition further comprises paraquat.

15. The method according to claim 9, wherein said pharmaceutical composition is for oral application.

16. The method according to claim 9, wherein said pharmaceutical composition is for topical application.

17. The method according claim 15, wherein an oral dosage unit of said pharmaceutical composition contains from 1 to 300 mg, preferably 1 to 150 mg, more preferably from 1 to 100 mg, and particularly from 1 to 50 mg of the agent(s).

18. The method according to claim 9, wherein the individual is a non-responder to interferon and/or ribavirin therapy.

19. The composition of claim 1, wherein said composition is in unit dosage form for oral administration, further comprising a pharmaceutically acceptable carrier suitable for oral administration, said agent(s) being present in said unit dosage form in an amount of from about 1 to 50 mg wherein said unit dosage form is a tablet or capsule.

20. The composition of claim 19, further comprising paraquat.

21-22. (canceled)

23. A method for regulating the production of Hepatitis C virus in cells or cell cultures and/or for preventing and/or treating Hepatitis C virus infection and/or diseases associated with HCV infection in cells or cell cultures, the method comprising administering a pharmaceutically effective amount of an agent selected from selenium, selenium salts, Vitamin D₃, all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, salts of 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (AHPN) to the cells or cell culture.

24-26. (canceled)

27. The method according to claim 23 or 55, further comprising administering paraquat.

28. The method of claim 9, wherein said composition is in a unit dosage form the pharmaceutical composition further comprising a pharmaceutically acceptable carrier.

29. The method according to claim 28, wherein the composition further comprises at least one of the compounds all trans retinoic acid, pegylated α-, β-, and/or γ-interferon, non-pegylated (standard) α, β-, and/or γ-interferon, and ribavirin.

30. The method according to claim 28, wherein the selenium salt is sodium selenite.

31. The method according to claim 28, wherein the composition further comprises paraquat.

32. The method according to claim 28, wherein said composition is for oral application.

33. The method according to claim 32, wherein the unit dosage form for oral application is a tablet or capsule.

34. The method according to claim 33, wherein the tablet or capsule comprises between 1 and 300 mg, preferably between 1 to 150 mg, more preferably between 1 to 100 mg, and particularly between 1 and 50 mg of the agent.

35. The method according to claim 28, wherein said composition is for topical application.

36-41. (canceled)

42. A method for regulating the expression of the human cellular protein glutathione peroxidase-gastrointestinal in an individual comprising administering to the individual a pharmaceutically effective amount of an agent selected from selenium, selenium salts, Vitamin D₃, all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (AHPN), wherein said agent inhibits or activates at least partially the transcription of DNA and/or the translation of RNA encoding said human cellular protein glutathione peroxidase-gastrointestinal.

43. The method according to claim 42, wherein the individual is a non-responder to interferon and/or ribavirin therapy.

44-45. (canceled)

46. A method for regulating the expression of the human cellular protein glutathione peroxidase-gastrointestinal in cells or cell culture comprising administering to the cells or cell culture a pharmaceutically effective amount of an agent selected from selenium, selenium salts, Vitamin D₃, all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, C₁-C₁₀ alkyl amide of 9-cis retinoic acid, salts of C₁-C₁₀ alkyl amide of 9-cis retinoic acid, C₁-C₁₀ alkyl esters of 9-cis retinoic acid, salts of C₁-C₁₀ alkyl esters of 9-cis retinoic acid, (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (AHPN), wherein said agent activates at least partially the transcription of DNA and/or the translation of RNA encoding said human cellular protein glutathione peroxidase-gastrointestinal.

47. A method for regulating the activity of the human cellular protein glutathione peroxidase-gastrointestinal in an individual comprising administering to the individual a pharmaceutically effective amount of an agent selected from selenium, selenium salts, Vitamin D₃, all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, C₁-C₁₀ alkyl amide of 9-cis retinoic acid, salts of C₁-C₁₀ alkyl amide of 9-cis retinoic acid, C₁-C₁₀ alkyl amide of 9-cis retinoic acid, salts of C₁-C₁₀ alkyl amide of 9-cis retinoic acid, (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl)retinamide (4-HPR), and 6-[3-(1-adamantyl)-4-hydroxyphenyl]-2-naphthalene carboxylic acid (AHPN), wherein said agent interacts with said human cellular protein glutathione peroxidase-gastrointestinal.

48. The method according to claim 47, wherein the individual is a non-responder to interferon and/or ribavirin therapy.

49. A method for regulating the activity of the human cellular protein glutathione peroxidase-gastrointestinal in cells or cell culture comprising administering to the cells or cell culture a pharmaceutically effective amount of an agent selected from selenium, selenium salts, Vitamin D₁₃, all trans retinoic acid, C₁-C₁₀ alkyl esters of all trans retinoic acid, salts of C₁-C₁₀ alkyl esters of all trans retinoic acid, C₁-C₁₀ alkyl amides of all trans retinoic acid, salts of C₁-C₁₀ alkyl amides of all trans retinoic acid, 9-cis retinoic acid, C₁-C₁₀ alkyl esters of 9-cis retinoic acid, salts of C₁-C₁₀ alkyl esters of 9-cis retinoic acid, C₁-C₁₀ alkyl amides of 9-cis retinoic acid, salts of C₁-C₁₀ alkyl amides of 9-cis retinoic acid, (E)-4-[2-(5,6,7,8-tetrahydro-5,5,8,8-tetramethyl-2-naphthalenyl-1-propenyl]benzoic acid (TTNPB), (4-[5,6,7,8-tetrahydro-5,5,8,8-tetramethyl-2-naphthalenyl)carboxamido]benzoic acid (AM-580), N-(4-hydroxyphenyl)retinamide (4-HPR), and 6-[3-(1-adamantyl)₄-hydroxyphenyl]-2-naphthalene carboxylic acid (AHPN), wherein said agent interacts with said human cellular protein glutathione peroxidase-gastrointestinal.

50. The method according to any one of claims 42, 46, 47, and 49, further comprising administering paraquat.

51. The composition according to claim 5, wherein the individual afflicted with a HCV infection and/or at least one disease associated with HCV infection is a non-responder to interferon and/or ribavirin therapy.

52. The method according to claim 15, wherein the individual is a non-responder to interferon and/or ribavirin therapy.

53. The method according to claim 9, wherein said agent activates at least partially the activity of the human cellular protein glutathione peroxidase-gastrointestinal or which activates or stimulates at least partially the production of said human cellular protein glutathione peroxidate-gastrointestinal.

54. The method according to claim 13, wherein said agent activates at least partially the activity of the human cellular protein glutathione peroxidase-gastrointestinal or which activates or stimulates at least partially the production of said human cellular protein glutathione peroxidase-gastrointestinal.

55. The method according to claim 18, wherein said agent activates at least partially the activity of the human cellular protein glutathione peroxidase-gastrointestinal or which activates or stimulates at least partially the production of said human cellular protein glutathione peroxidase-gastrointestinal.

56. The method according to claim 23, wherein said agent activates at least partially the activity of the human cellular protein glutathione peroxidase-gastrointestinal.
